(19) United States
(12) Patent Application Publication
(10) Pub. No.: US 2002/0133393 A1
(43) Pub. Date: Sep. 19, 2002

(54) Viewing information collection system and method using data braodcasting, and broadcast receiver, viewing information server, shop terminal, and advertiser terminal used therein

(76) Inventors: Hidenori Tatsumi, Higashihiroshima (JP); Eiji Ueda, Toyota-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/096,824

(22) Filed: Mar. 14, 2002

(30) Foreign Application Priority Data
Mar. 15, 2001 (JP) 2001-73728

(51) Int. Cl. G06F 17/60

(52) U.S. Cl. 705/10

(57) ABSTRACT

Provided is a viewing information collection system in which information about “who viewed which CM program when and where with how much interest”, or information indicating whether the CM program has successfully induced the viewer to purchase the advertising product is automatically collected and processed, and the resulting marketing information becomes worth knowing for advertisers and broadcast stations. A broadcast facility 1 provided in a broadcast station broadcasts program data of a CM program together with the associated information indicating a sponsor code, product name, and others. On receiving the CM program, a viewer's broadcast receiver 2 extracts the associated information, and automatically transmits it to a viewing information server 3 together with viewing time/day, area information, and a viewer profile which is previously stored. The viewing information server 3 then stores thus received viewing information into a database, generates marketing information through statistical analysis, and provides it to an advertiser terminal 4.

### BACKGROUND OF THE INVENTION

1. Field of the Invention

The present invention relates to viewing information collection systems and methods using data broadcasting, and broadcast receivers, viewing information servers, shop terminals, and advertiser terminals used therein. More specifically, the present invention relates to systems and methods for automatically collecting, in data broadcasting, specific additional information responsively when a relevant broadcast program is received on the viewer's side for use of ratings research, market research, and others, and also relates to terminals for receiving broadcast programs and their additional information, servers and terminals for making collected information available, and terminals for using the information.

2. Description of the Background Art

In order to see the ratings for any specific broadcast programs, conventionally, a ratings research company places ratings measurement terminals in sample households randomly selected and recruited for statistics. Information about which household is watching what broadcast program collected by such ratings measurement terminals is forwarded to a server of the research company over a telephone line at given time intervals. The information collected in the server is then compiled by the research company to figure out the ratings on a broadcast program basis. Here, the broadcast program is presumably composed of a substantial program part (hereinafter, substantial program) and a commercial part (hereinafter, CM program). The system disclosed in PC (WO) 61-501542 is exemplified as the conventional type.

The resulting ratings information is distributed at cost to broadcast stations, advertisers, and the like, and utilized to make decisions about broadcast programming and commercial advertising.

The issue here is, data collected by such conventional ratings research merely tells who watches what broadcast program at what time, but is not detailed enough to tell if the CM program during the substantial program has successfully raised the viewers' interest, and if so, to what degree. Moreover, information as a result of compiling such data is no more than a measure of sample households whichever provided with the ratings measurement terminals, but researching every single citizen for the ratings is impracticable. Therefore, such information is not useful and helpful enough to give advertisers of CM programs good feedback about purchase of commercial time, product development, and others.

Although collecting customer information at the point of sale has been conventionally proposed as by the system exemplarily disclosed in PC(WO)2-503246, the resulting information does not specifically tell how the CM program has induced the customer's purchase. In the current circumstances, in order to know the correlation between a CM program and a product purchase, popularly used is a survey card packed with the product to ask customers what encouraged them to purchase the product. The problem of such survey cards is that information collection requires time and effort, and customers do not always return those. Therefore, information collected thereby often lacks accuracy.

As such, with the conventional ratings measurement, none of the information resultantly derived satisfies population parameters of sample subjects, immediacy, survey items (details), and survey accuracy. Some survey items are not practical for information collection. As a result, the use of the ratings information is restricted to a limited number of purposes, and thus the advertisers and broadcast stations find the information not useful and effective enough.

### SUMMARY OF THE INVENTION

Therefore, an object of the present invention is to provide viewing information collection systems and methods for supplying advertisers and broadcast stations with marketing information worth knowing about broadcast programs, and terminals and servers used therein. Such marketing information is derived by automatically collecting and processing viewing information telling “who watched what broadcast program at what time with how much interest” using specific information previously added to broadcast programs.

Another object of the present invention is to provide viewing information collection systems and methods for supplying advertisers and broadcast stations with marketing information which properly tells the correlation between a CM program and a product purchase, and terminals and servers used therein. Such marketing information is derived by, at the point of sale, automatically collecting and processing information at the shop if the customer has been induced by the CM program to buy the product.

The present invention has the following features to attain the objects above.

A first aspect of the present invention is directed to a viewing information collection system utilizing a broadcast environment in which a value added service is provided through data broadcasting. Such a system comprises: a broadcast facility operable to generate program data composed of video information and audio information of a broadcast program, and program additional information associated with the broadcast program, and using data broadcasting, broadcast the program additional information together with the program data; a broadcast receiver which is provided plurally and operable to receive the program data and the program additional information of the program according to a viewer's selection, and automatically generate and transmit viewing information which is a combination of program reception information partially or entirely extracted from the program additional information specifying the broadcast program, and viewers information about the viewer; and a viewing information server operable to receive the viewing information transmitted from each of the broadcast receivers, analyze and process the viewing information to generate marketing information meeting a broadcast program provider's needs, and sends out the resulting marketing information to the broadcast program provider.

As described above, in the first aspect, the marketing information provided to advertisers and broadcast stations can be useful and helpful as indicating “who viewed what broadcast program when and where”. Accordingly, the advertisers become able to determine whether their CM programs have been on the air on the appropriate day of the week, broadcast time, broadcast area, and the like, for their target users. On the other hand, the broadcast stations can be provided with data showing correlation between the target users and the CM program broadcast times, and such data is useful and effective for selling broadcast times to advertisers.

In the first aspect, the broadcast receiver may transmit the generated viewing information to the viewing information server at the end of viewing the broadcast program, or after storage of a predetermined period of time.

In the former case, information transmission can become less often, successfully leading to effective use of the communications resource. In the latter case, the viewing information can be collected in real time.

In the first aspect, the viewing information server may be limited in number to one to solely collect and manage the viewing information, or two or more of those may be provided to each independently collect and manage the viewing information.

In the former case, a continuous connection can be established between the broadcast receivers and the viewing information server, resulting in effective information transmission. In the latter case, the viewing information server may be individually provided to each of advertisers and broadcast stations.

Preferably, the program additional information may be at least provided with a unit of information for specification of a broadcast station, a broadcast program, an advertiser, or a product.

Further, preferably, the viewers information may be provided with a unit of information indicating day and time when the viewer viewed the broadcast program, a unit of information at least about the viewer's age, sex, occupation, or preference, a unit of information indicating an area in which the viewer viewed the broadcast program, and/or viewing pattern information indicating which part of the broadcast program is viewed by the viewer.

By using such information, the resulting marketing information can be worth knowing.

Preferably, the program additional information may be provided with at least one of image data available in the CM program, coupon data usable to purchase a product advertised in the CM program, and link data to access a Web server from which detailed information about the broadcast program is available. If this is the case, the link data may be provided with a predetermined password for access permission to restrict the broadcast receivers to access the Web server.

Such information is contributable to the viewers' program viewing. In particular, providing such a password only to the viewers who have actually viewed the broadcast program will encourage the viewers to view the broadcast program.

Preferably, the viewers information may include interest level indicating how much interest the viewer showed toward the broadcast program.

In such a case, the broadcast receiver may change the interest level between a case of acquiring any one of the image data of the broadcast program, the coupon data thereof, and the link data thereof, and a case where the viewer viewed the broadcast program.

The broadcast receiver may also change the interest level among cases of acquiring the image data of the broadcast program, receiving the coupon data thereof, and receiving the link data thereof, and a case where the viewer merely viewed the broadcast program.

Further, when acquiring the link data, the broadcast receiver may change the interest level by determining whether the corresponding Web server is actually accessed.

As such, by using the interest level as such, the resulting marketing information becomes useful and effective as is telling “who viewed which broadcast program when and where with how much interest”. That is, the marketing information surely conveys ratings information, but more than that, is quite usable for advertisers' CM programming and product development, and broadcast stations' broadcast scheduling and broadcast time sales. Here, the interest level may be inputted by the viewer to his/her broadcast receiver.

The program additional information is preferably provided with item selection information indicating what information item the broadcast program provider is wanting to collect out of the viewers information, and the viewers information sent out from the broadcast receiver to the viewing information server includes only the information item indicated by the item selection information.

Alternatively, the broadcast receiver may forward, to the viewing information server, the viewers information including only information item previously selected and set to the broadcast receiver by the viewer.

As such, only needed information item(s) are forwarded from the broadcast receiver to the viewing information server. Accordingly, the information amount can be reduced therebetween, successfully leading to effective use of the communications resource of the system, and effective information collection for advertisers. Also, by allowing the viewers to do information item selection, their privacy can be accordingly protected.

Further, in the first aspect, the broadcast program provider of a CM program provided with the marketing information may analyze a correlation between a targeting viewership and a broadcast time, and if the correlation is not considered optimal, the broadcast facility may control a broadcast schedule for the CM program based on an optimizing instruction coming from the broadcast program provider.

Therefore, with such a control of the broadcast schedule based on the marketing information, the viewers' response to the CM program can be directly and swiftly reflected to CM programming later on.

A second aspect of the present invention is directed to a viewing information collection system utilizing a broadcast environment in which a value added service is provided through data broadcasting. Such a system comprises: a broadcast facility operable to generate program data composed of video information and audio information of a broadcast program, and program additional information associated with the broadcast program, and using data broadcasting, broadcast the program additional information together with the program data; a broadcast receiver which is provided plurally and operable to receive the program data and the program additional information of the program, according to a viewer's selection, and automatically generate and store viewing information which is a combination of program reception information partially or entirely extracted from the program additional information specifying the broadcast program, and viewers information about the viewer; and a shop terminal operable to receive the viewing information from the broadcast receiver to allow the viewer to purchase a product advertised in a CM program, and analyze and process the viewing information to generate shop information meeting a broadcast program provider's needs, and sends out the resulting shop information to the broadcast program provider.

As described above, in the second aspect, a single terminal allows the users to view CM programs, support the users' product purchase behavior through the medium of product information downloaded thereto, and perform user authentication for payment. Further, the single terminal can successively collect various kinds of information about the viewers. Accordingly, the viewing information indicating “who viewed which CM program when and where with how much interest”, and the shop information indicating “which product is sold how many and how much at which shop” can be associated together, making the resulting marketing information more worth knowing.

Preferably, the program additional information includes at least either image data available in the CM program or coupon data usable to purchase the product advertised in the CM program, and the image data or the coupon data is transmitted from the broadcast receiver to the shop terminal to know what product the viewer is wanting to purchase.

With such a structure, to purchase advertising products, all the viewers have to do is to show either the image data or the coupon data downloaded from the CM program at the shop. Accordingly, they do not bother to shop around to buy the product.

A third aspect of the present invention is directed to a viewing information collection system utilizing a broadcast environment in which a value added service is provided through data broadcasting. Such a system comprises: a broadcast facility operable to generate program data composed of video information and audio information of a broadcast program, and program additional information which is associated with the broadcast program and including link data to access a Web server from which detailed information about the broadcast program is available, and using data broadcasting, broadcast the program additional information together with the program data; a broadcast receiver which is provided plurally and operable to receive the program data and the program additional information of the program, according to a viewer's selection, and automatically generate and store the link data, and viewing information which is a combination of program reception information partially or entirely extracted from the program additional information specifying the broadcast program, and viewers information about the viewer; and a Web server operable to provide a service according to an access by each of the broadcast receivers using the link data, and when accessed, receive the viewing information, analyze and process the viewing information to generate service use information meeting a broadcast program provider's needs, and sends out the resulting service use information to the broadcast program provider.

As described above, in the third aspect, without using the viewing information server, information about the viewers who showed strong interest toward the CM program becomes collectable. Accordingly, information about “who viewed which CM program when and where” can be directly associated with information telling that the specific viewers have accessed the Web server with strong interest, making the resulting marketing information more worth knowing. Further, with no viewing information server provided, the advertisers can independently collect the viewing information.

A fourth aspect of the present invention is directed to a broadcast receiver operable to receive program data composed of video information and audio information of a broadcast program, and program additional information associated with the broadcast program which are both broadcast from a broadcast facility using data broadcasting. Such a broadcast receiver comprises: a reception section operable to receive the program data and the program additional information of the program, according to a viewer's selection; a generation section operable to automatically generate viewing information which is a combination of program reception information partially or entirely extracted from the program additional information specifying the broadcast program, and viewers information about the viewer; and a transmission section operable to transmit the viewing information to a viewing information server operable to generate marketing information analyzed and processed to meet a broadcast program provider's needs, and sends out the resulting marketing information to the broadcast program provider.

In the fourth aspect, the generated viewing information may be transmitted to the viewing information server at the end of viewing the broadcast program, or after storage of a predetermined time period.

Preferably, the viewers information may include a unit of information indicating day and time when the viewer viewed the broadcast program, a unit of information at least about the viewer's age, sex, occupation, or preference, a unit of information indicating a area in which the viewer viewed the broadcast program, and/or viewing pattern information indicating which part of the broadcast program is viewed by the viewer.

Also, preferably, the viewers information may be provided with interest level indicating how much interest the viewer showed toward the broadcast program.

Here, when the program additional information includes at least one of image data available in the broadcast program, coupon data usable to purchase a product advertised in the broadcast program, and link data to access a Web server from which detailed information about the broadcast program is available, the interest level may be changed between a case of acquiring any one of the image data of the broadcast program, the coupon data thereof, and the link data thereof, and a case where the viewer viewed the broadcast program.

Similarly, when the program additional information includes image data available in the broadcast program, coupon data usable to purchase a product advertised in the broadcast program, and link data to access a Web server from which detailed information about the broadcast program is available, the interest level may be changed among cases of acquiring the image data of the broadcast program, receiving the coupon data thereof, and receiving the link data thereof, and a case where the viewer viewed the broadcast program.

Further, in response to acquisition of the link data, the interest level may be changed by determining whether the corresponding Web server is actually accessed.

Here, the interest level may be inputted by the viewer to his/her broadcast receiver.

The viewers information sent out to the viewing information server preferably includes only the information item indicated by the item selection information which is a part of the program additional information and indicating what information item the broadcast program provider is wanting to collect out of the viewers information.

Alternatively, the viewers information sent out to the viewing information server preferably includes only information item previously selected and set by the viewer.

A fifth aspect of the present invention is directed to a broadcast receiver operable to receive program data composed of video information and audio information of a broadcast program, and program additional information associated with the broadcast program which are both broadcast from a broadcast facility using data broadcasting. Such a broadcast receiver comprises: a reception section operable to receive the program data and the program additional information of the program, according to a viewer's selection; a generation section operable to automatically generate viewing information which is a combination of program reception information partially or entirely extracted from the program additional information specifying the broadcast program, and viewers information about the viewer; and a transmission section operable to transmit the viewing information to a shop terminal operable to enable the viewer's product purchase, generate shop information which is analyzed and processed to meet a broadcast program provider's needs, and sends out the resulting shop information to the broadcast program provider.

Here, when the program additional information includes at least either image data available in the broadcast program, or coupon data usable to purchase a product advertised in the broadcast program, the image data or the coupon data is preferably transmitted to the shop terminal to know what product the viewer is wanting to purchase.

A sixth aspect of the present invention is directed to a broadcast receiver operable to receive program data composed of video information and audio information of a broadcast program, and program additional information associated with the broadcast program and including link data used to access a Web server from which detailed information about the broadcast program is available, both of which are broadcast from a broadcast facility using data broadcasting. Such a broadcast receiver comprises: a reception section operable to receive the program data and the program additional information of the program, according to a viewer's selection; a generation section operable to automatically generate and store the link data, and viewing information which is a combination of program reception information partially or entirely extracted from the program additional information specifying the broadcast program, and viewers information about the viewer; and a transmission section operable to provide a service according to an access using the link data, and transmit the viewing information to a Web server which generates service use information analyzed and processed to meet a broadcast program provider's needs, and sends out the resulting shop information to the broadcast program provider.

A seventh aspect of the present invention is directed to a viewing information server operable to collect viewing information which is a combination of program reception information specifying a broadcast program and viewers information about a viewer, both of which are stored at the time of program reception in a broadcast receiver which is provided plurally and operable to receive program data composed of video information and audio information of the broadcast program, and program additional information associated with the broadcast program, both of which are broadcast from a broadcast facility using data broadcasting. Such a viewing information server comprises: a collection section operable to collect the viewing information from each of the broadcast receivers; a generation section operable to generate marketing information by analyzing and processing the collected viewing information to meet a broadcast program provider's needs; and a sending-out section operable to send out the generated marketing information to the broadcast program provider.

Here, preferably, the viewing information coming from each of the broadcast receivers is collectively collected and managed.

An eighth aspect of the present invention is directed to a shop terminal operable to collect, at the point of sale, viewing information which is a combination of program reception information specifying a broadcast program and viewers information about a viewer, both of which are stored at the time of program reception in a broadcast receiver operable to receive program data composed of video information and audio information of the broadcast program, and program additional information associated with the broadcast program, both of which are broadcast from a broadcast facility using data broadcasting. Such a shop terminal comprises: a collection section operable to collect, at the point of sale, the viewing information relating to a product from the broadcast receiver; a generation section operable to generate shop information by analyzing and processing the collected viewing information to meet a broadcast program provider's needs; and a sending-out section operable to send out the generated shop information to the broadcast program provider.

Preferably, when the program additional information at least includes either image data available in the broadcast program, or coupon data usable to purchase a product advertised in the broadcast program, the image data or the coupon data is received from the broadcast receiver to know what product the viewer is wanting to purchase.

A ninth aspect of the present invention is directed to an advertiser terminal operable to receive marketing information which is generated by a viewing information server by analyzing and processing, to meet a broadcast program provider's needs, viewing information which is a combination of program reception information specifying a broadcast program and viewers information about a viewer, both of which are stored at the time of program reception in a broadcast receiver operable to receive program data composed of video information and audio information of the broadcast program, and program additional information associated with the broadcast program, both of which are broadcast from a broadcast facility using data broadcasting. Such an advertiser terminal comprises: a collection section operable to receive the marketing information from the viewing information server; an analysis section operable to analyze a correlation between a targeting viewership and a broadcast time of a CM program based on the received marketing information; and a control section operable to control a broadcast schedule by transmitting, to the broadcast facility, CM control information instructing to optimize the broadcast time of the CM program.

A tenth aspect of the present invention is directed to a viewing information collection method utilizing a broadcast environment in which a value added service is provided through data broadcasting. In a broadcast facility provided in a broadcast station, program data composed of video information and audio information of a broadcast program, and program additional information associated with the broadcast program are generated, and the program additional information is broadcast together with the program data using data broadcasting. In a broadcast receiver which is provided plurally and each belonging to a viewer, the program data and the program additional information of the program are received according to the viewer's selection, and viewing information which is a combination of program reception information partially or entirely extracted from the received program additional information specifying the broadcast program, and viewers information about the viewer is automatically generated and transmitted to a predetermined viewing information server. In the viewing information server, the viewing information coming from each of the broadcast receiver is received, marketing information meeting a broadcast program provider's needs is generated by analyzing and processing the received viewing information, and the marketing information is sent out to the broadcast program provider.

An eleventh aspect of the present invention is directed to a viewing information collection method utilizing a broadcast environment in which a value added service is provided through data broadcasting. In a broadcast facility provided in a broadcast station, program data composed of video information and audio information of a broadcast program, and program additional information associated with the broadcast program are generated, and the program additional information is broadcast together with the program data using data broadcasting. In a broadcast receiver which is provided plurally and each belonging to a viewer, the program data and the program additional information of the program are received according to the viewer's selection, and viewing information which is a combination of program reception information partially or entirely extracted from of the received program additional information specifying the broadcast program, and viewers information about the viewer is automatically generated and stored. In a predetermined shop terminal, when a product advertised in a CM program is purchased by the viewer, the viewing information is received from the broadcast receiver, shop information meeting a broadcast program provider's needs is generated by analyzing and processing the received viewing information, and the shop information is sent out to the broadcast program provider.

A twelfth aspect of the present invention is directed to a viewing information collection method utilizing a broadcast environment in which a value added service is provided through data broadcasting. In a broadcast facility provided in a broadcast station, program data composed of video information and audio information of a broadcast program, and program additional information associated with the broadcast program and including link data to access a Web server from which detailed information about the broadcast program is available are generated, and the program additional information is broadcast together with the program data using data broadcasting. In a broadcast receiver which is provided plurally and each belonging to a viewer, the program data and the program additional information of the program are received according to the viewer's selection, and viewing information which is a combination of program reception information partially or entirely extracted from of the received program additional information specifying the broadcast program, and viewers information about the viewer, and the link data are automatically generated and stored. In the Web server, the viewing information is received at the time of an access by the broadcast receiver using the link data to provide a service according to the access, service use information meeting a broadcast program provider's needs is generated by analyzing and processing the received viewing information, and the service use information is sent out to the broadcast program provider.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of a viewing information collection system according to first to fourth embodiments of the present invention;

FIG. 2 is an illustration demonstrating what information is to be exchanged in the viewing information collection system of the first to third embodiments;

FIG. 3 is a block diagram showing in detail an exemplary structure of a broadcast facility 1;

FIG. 4 is an illustration demonstrating the structure of broadcast data coming from the broadcast facility 1;

FIG. 5 is an illustration demonstrating the data structure of program additional information 45 in the first embodiment;

FIG. 6 is a block diagram showing in detail an exemplary structure of a broadcast receiver 2a (stay-at-home type) in the first embodiment;

FIG. 7 is a block diagram showing in detail an exemplary structure of a broadcast receiver 2b (mobile type) in the first embodiment;

FIG. 8 is an illustration demonstrating exemplary viewing information 80 to be collected by the broadcast receiver 2 in the first embodiment;

FIG. 9 is a flowchart of the processes to be executed in the broadcast receiver 2 in the first embodiment;

FIG. 10 is a block diagram showing in detail an exemplary structure of a viewing information server 3;

FIG. 11 is an illustration showing an exemplary collective viewing information database 303 constructed in the viewing information server 3 in the first embodiment;

FIG. 12 is an illustration showing exemplary marketing information derived by analyzing and processing collective viewing information;

FIG. 13 is a block diagram showing in detail an exemplary structure of an advertiser terminal 4 in the first to third embodiments;

FIG. 14 is an exemplary bar chart as a result of using the marketing information of FIG. 12;

FIG. 15 is an illustration demonstrating the data structure of program additional information 45′ in the second embodiment;

FIG. 16 is a flowchart of the processes to be executed in the broadcast receiver 2 in the second embodiment;

FIG. 17 is an illustration demonstrating exemplary viewing information 80′ to be collected by the broadcasting receiver 2 in the second embodiment;

FIG. 18 is an illustration demonstrating an exemplary collective viewing information database 303 constructed in the viewing information server 3 in the second embodiment;

FIG. 19 is an illustration showing an exemplary display screen of the broadcast receiver 2 in the second embodiment;

FIG. 20 is an illustration demonstrating the data structure of program additional information 45″ in the third embodiment;

FIG. 21 is a flowchart of the processes to be executed in the broadcast receiver 2 in the third embodiment;

FIG. 22 is an illustration demonstrating exemplary viewing information 80″ to be collected by the broadcast receiver 2 in the third embodiment;

FIG. 23 is an illustration demonstrating exemplary collective viewing information database 303 constructed in the viewing information server 3 in the third embodiment;

FIG. 24 is a block diagram showing in detail an exemplary structure of an advertiser terminal 4′ in the fourth embodiment;

FIG. 25 is an illustration demonstrating what information is to be exchanged in the viewing information collection system in the fourth embodiment;

FIG. 26 is a block diagram showing the structure of a viewing information collection system according to a fifth embodiment of the present invention;

FIG. 27 is an illustration demonstrating what information is to be exchanged in the viewing information collection system of the fifth embodiment;

FIG. 28 is a block diagram showing in detail an exemplary structure of a broadcast receiver 2c (mobile type) in the fifth embodiment;

FIG. 29 is a flowchart of the processes to be executed in the broadcast receiver 2c in the fifth embodiment;

FIG. 30 is a block diagram showing in detail an exemplary structure of a shop terminal 6;

FIG. 31 is an illustration demonstrating exemplary shop information 330 to be stored in the shop terminal 6;

FIG. 32 is a block diagram showing the structure of a viewing information collection system according to a sixth embodiment of the present invention;

FIG. 33 is an illustration demonstrating what information is to be exchanged in the viewing information collection system of the sixth embodiment;

FIG. 34 is a flowchart of the processes to be executed in the broadcast receiver 2 in the sixth embodiment;

FIG. 35 is a flowchart of the processes to be executed in the broadcast receiver 2 in the sixth embodiment; and

FIG. 36 is a block diagram showing in detail an exemplary structure of a Web server 5.

### DESCRIPTION OF THE PREFERRED EMBODIMENTS

In the below, taking as an example a case where viewing information relating to CM programs for digital broadcasting is collected and processed, embodiments of a viewing information collection system of the present invention are described with reference to the accompanying drawings. Here, the present invention is surely applicable even if the viewing information to be collected and processed is relating to substantial programs.

(First Embodiment)

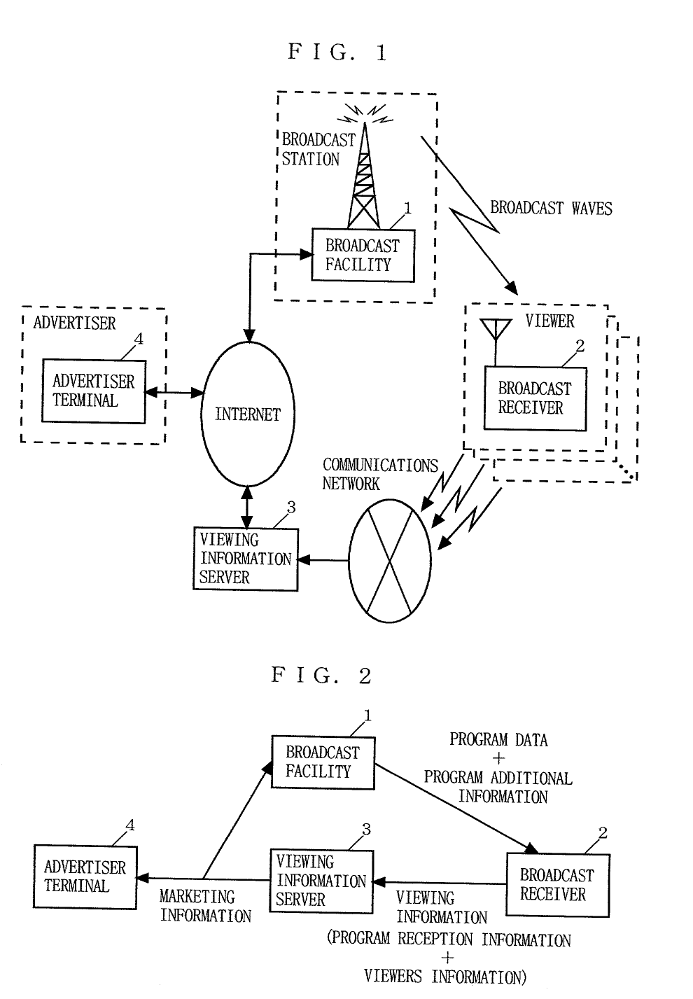

Referring to FIGS. 1 and 2, described briefly first is the entire structure of the viewing information collection system according to a first embodiment of the present invention.

In FIG. 1, the viewing information collection system of the first embodiment includes a broadcast facility 1 provided in a broadcast station, a plurality of a viewer's broadcast receiver 2, a viewing information server 3 for collecting and processing viewing information, and an advertiser terminal 4. Here, the advertiser terminal 4 denotes a terminal belonging to advertisers, advertising agencies, and broadcast stations wherever the viewing information isused. Although there appears in FIG. 1 that the viewing information server 3 is belonging to a ratings research company and others, this is not restrictive. The viewing information server 3 may be provided to either an advertiser or a broadcast station, or both of those if the server is provided plurally. In the below, the advertiser and the broadcast station are collectively referred to as a broadcast program provider.

Referring to FIG. 2, the program data of a CM program and its given program additional information are multiplexed together for broadcasting from the broadcast facility 1. When receiving the broadcast waves of the CM program, the broadcast receiver 2 transmits, to the viewing information server 3 over a communications network, program reception information which is based on the program additional information, indicating that the broadcast receiver 2 has received the CM program, and viewers information indicating “who has received the CM program when and where”. In the below, the program reception information and the viewers information are collectively referred to as viewing information. The viewing information server 3 receives the viewing information from the broadcast receiver 2, compiles the viewing information to generate collective viewing information, and stores it into a database. The viewing information server 3 also analyzes and processes thus stored collective viewing information to generate marketing information which is worth knowing. This marketing information (or collective viewing information) is distributed to the advertiser terminal 4 and the broadcast facility 1 at regular intervals, or responding to any request coming from the advertisers and broadcast stations. Here, the marketing information may be partially or entirely distributed at cost to general users over the Internet, for example.

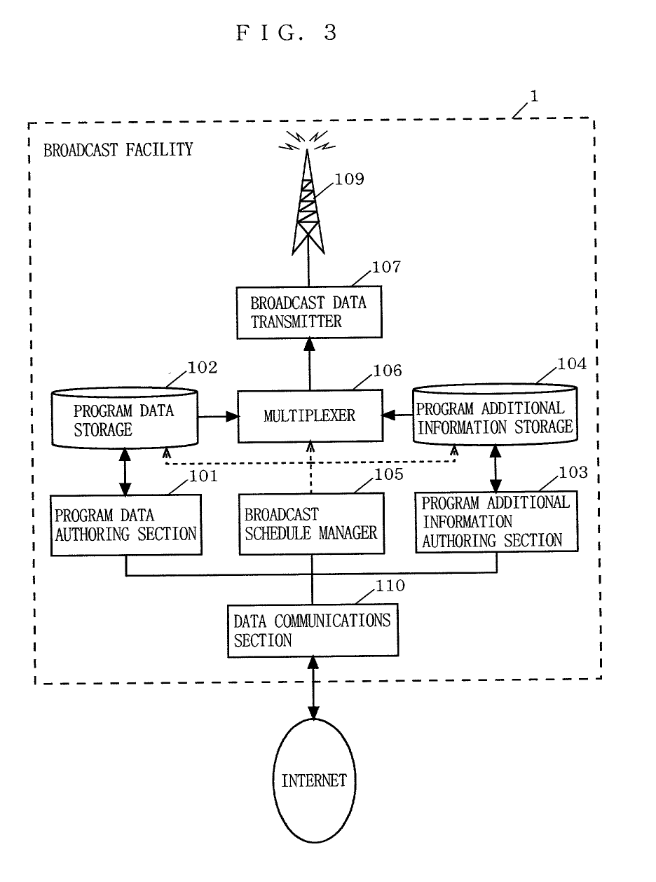

As to the constituents of the viewing information collection system of the first embodiment, their operations are respectively described referring to FIGS. 3 to 14.

Described first is about the broadcast facility 1 referring to FIGS. 3 to 5.

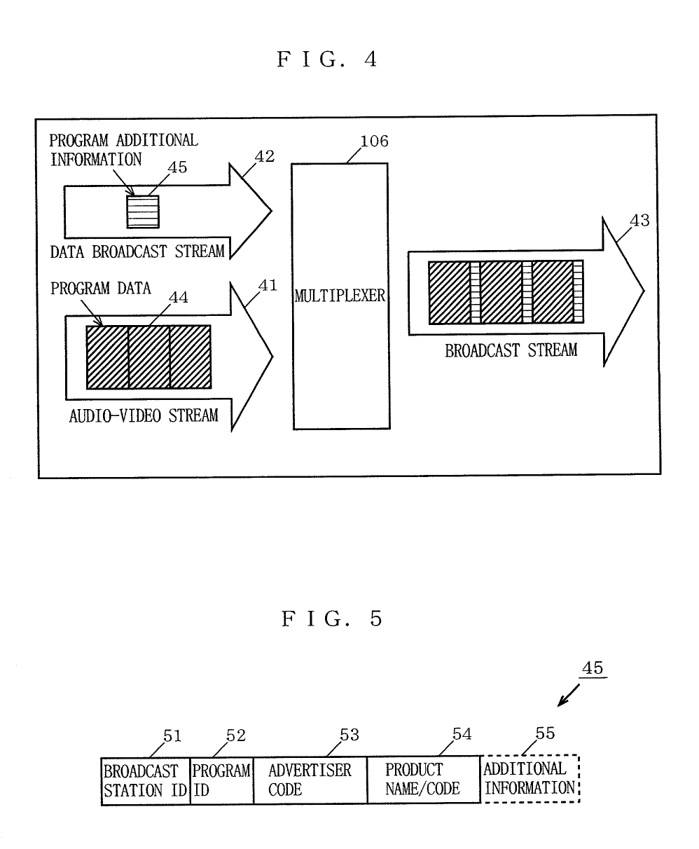

In digital broadcasting in FIG. 4 example, presumably, an audio-video stream 41 and a data broadcast stream 42 are multiplexed together, and resultantly derived is a broadcast stream 43 which will be transmitted as the broadcast waves. Herein, the audio-video stream 41 is used for video and sound broadcasting, while the data broadcast stream 42 is used for still-picture broadcasting, graphic broadcasting, and the like, to provide additional services. In FIG. 4 example, the audio-video stream 41 is composed of program data 44 and a header part (not shown) which are provided, respectively, as many as the CM programs included therein. Program additional information 45 associated with each of the CM programs is defined in the data broadcast stream 42. Here, the program additional information 45 may be defined in the header part of the broadcast stream 43.

As briefly described above, the program additional information 45 is provided for use after transmitted to the viewing information server 3 by the broadcast receiver 2 whichever received the information. Thus, the program additional information 45 may vary in structure depending on how the information will be used, and the structure of FIG. 5 is a possibility. In FIG. 5 example, the program additional information 45 is structured by a broadcast station ID 51 for specifying which broadcast station broadcast the CM program, a program ID 52 for specifying the CM program, an advertiser code 53 for specifying an advertiser of the CM program, a product name/code 54 of the advertising product, and any other needed additional information 55. Here, the structure of the program additional information 45 is not restrictive to the above, and any other information can be freely included.

In FIG. 3, the broadcast facility 1 includes a program data authoring section 101, a program data storage 102, a program additional information authoring section 103, a program additional information storage 104, a broadcast schedule manager 105, a multiplexer 106, a broadcast data transmitter 107, an antenna 109, and a data communications section 110.

The program data authoring section 101 authors the program data 44. The program data storage 102 stores thus authored program data 44 therein. The program additional information authoring section 103 authors the program additional information 45. The program additional information storage 104 stores thus authored program additional information 45 therein. The multiplexer 106 multiplexes the program data 44 and the program additional information 45 in storage under the control of the broadcast schedule manager 105 to generate the broadcast stream 43 (see FIG. 4). The broadcast data transmitter 107 then transmits the resulting broadcast stream 43 as the broadcast waves from the antenna 109 for broadcasting. The data communications section 110 communicates with outside for the exchange of data and program materials.

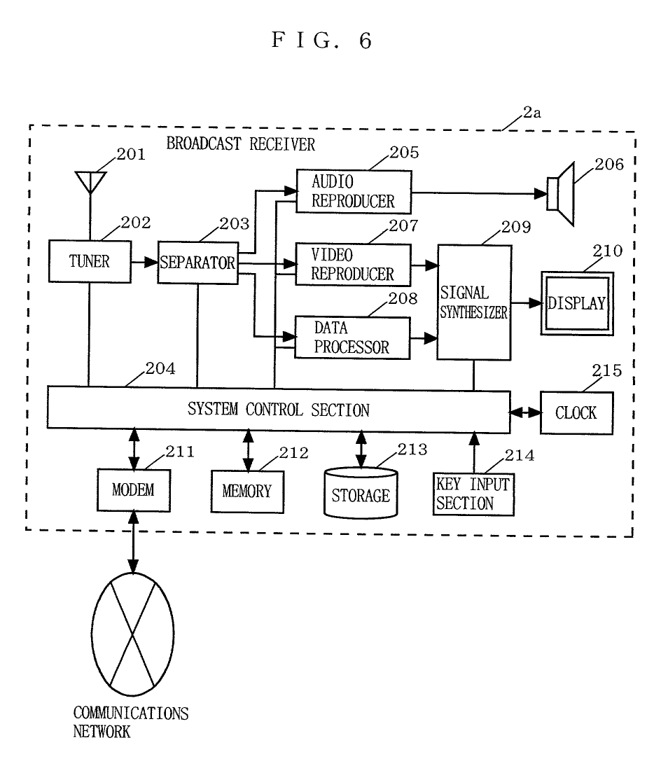

Referring to FIGS. 6 to 9, described next is about the broadcast receiver 2.

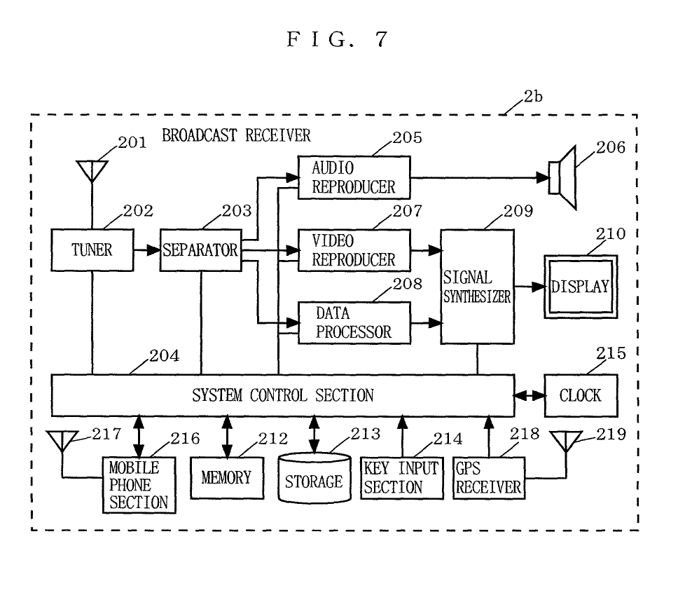

As to the broadcast receiver 2 of the present invention, there may be two types of structures: one is a stay-at-home type (see FIG. 6) exemplified by television receivers, and the other is a mobile type (see FIG. 7) exemplified by mobile phones. In the below, the broadcast receiver 2 is assumed as being a broadcast receiver 2a of the stay-at-home type, and a supplemental description is provided if there is any difference from a broadcast receiver 2b of the mobile type.

Referring to FIG. 6, the broadcast receiver 2a of the stay-at-home type includes an antenna 201, a tuner 202, a separator 203, a system control section 204, an audio reproducer 205, a speaker 206, a video reproducer 207, a data processor 208, a signal synthesizer 209, a display 210, a modem 211, a memory 212, a storage 213, a key input section 214, and a clock 215. The broadcast receiver 2b of the mobile type shown in FIG. 7 includes a mobile phone section 216, and an antenna 217 instead of the modem 211, and further includes a GPS receiver 218, and an antenna 219.

In digital broadcasting, the broadcast waves coming from the broadcast antenna 201 are received and demodulated by the tuner 202, and forwarded to the separator 203. Therein, the demodulated broadcast waves are then separated into a video stream and an audio stream which are parts of the audio-video stream 41 of FIG. 4, and the data broadcast stream 42. The audio stream is decoded by the audio reproducer 205, and reproduced as an audio signal. The resulting audio signal is outputted from the speaker 206. The video stream is decoded by the video reproducer 207, and reproduced as a video signal. The data broadcast stream 42 is subjected to any needed processes in the data processor 208, and reproduced as a video signal for supplementary screens of graphics and still-pictures, for example. Both reproduced video signals are synthesized by the signal synthesizer 209 for display on the display 210.

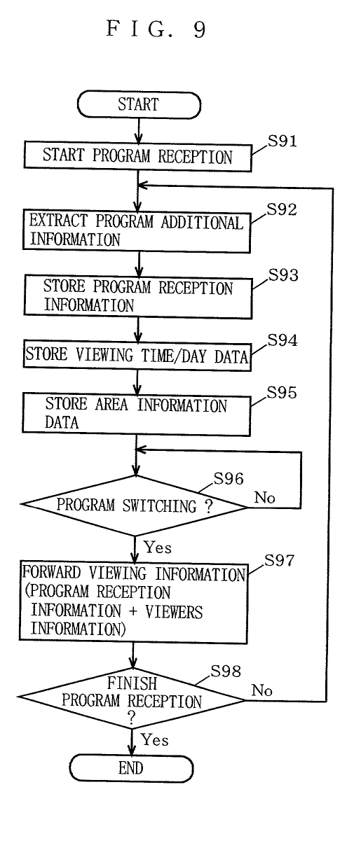

The program additional information 45 in the data broadcast stream 42 is processed by going through the system control section 204 composed by a micro processor and others, the memory 212, and the storage 213 in accordance with the procedure of FIG. 9. Here, before the processes of FIG. 9 are started, the storage 213 previously stores a viewer profile which indicates the viewer's age, sex, occupation code, and others provided through the key input section 214.

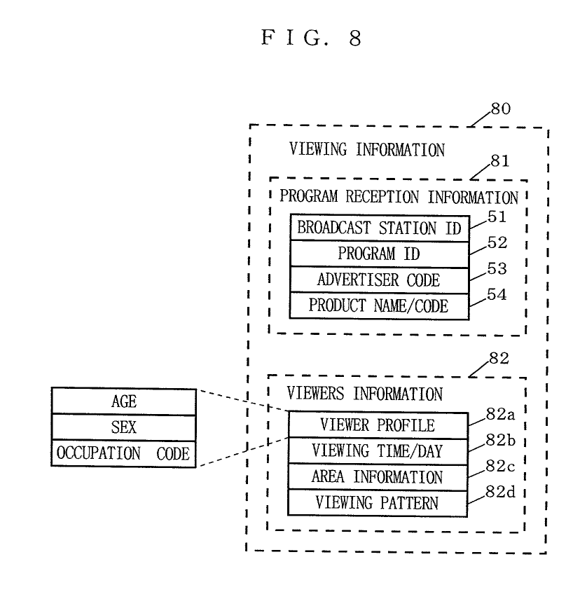

In FIG. 9, responding to the start of CM program reception (step S91) , the program additional information 45 associated with the CM program is extracted from the data broadcast stream 42 (step S92) Then, out of the program additional information 45, any information needed to be forwarded to the viewing information server 3 is stored in the memory 212 as program reception information 81 (step S93). Referring to FIG. 8, the program reception information 81 exemplarily includes, as a package, the broadcast station ID 51, the program ID 52, the advertiser code 53, and the product name/code 54. Next, data about viewing time and day coming from the clock 215 provided in the broadcast receiver 2 is stored in the memory 212 as viewing time/day 82b (step S94). Thereafter, data about the area where the broadcast receiver 2 is placed, i.e., the area where the CM program is received, is stored in the memory 212 as area information 82c (step S95). This area information 82c is used to see if viewers taste for broadcast programs vary depending on areas. If the broadcast receiver 2 is of the stay-at-home type (FIG. 6), data previously stored in the storage 213 based on addresses, zip codes, or the like, is used as the area information 82c. If the broadcast receiver 2 is of the mobile type (FIG. 7) on the other hand, data provided by the GPS receiver 218 is used as the area information 82c.

In the next step S96, determined is whether or not the CM program has been over, or the subsequent CM program has been started, i.e., whether CM program switching has occurred. This determination is made by monitoring, for any change, the header parts of the broadcast stream 43 or the program ID 52 of the program additional information 45. If CM program switching is determined as occurred, the information so far stored in the memory 212, i.e., the viewer profile 82a, the viewing time/day 82b, the area information 82c, and a viewing pattern 82d, are packaged into one viewers information 82. Similarly, this viewers information 82 and the program reception information 81 are packaged into one viewing information 80 (see FIG. 8).

Here, the viewing pattern 82d is information used to determine which part of the CM program has been viewed. For example, if the CM program is completely viewed, indicated is “pattern 1”. If the first half of the CM program is viewed, “pattern 2” is indicated, and if the second half is viewed, indicated is “pattern 3”. Such a viewing pattern 82d tells the advertisers which part of the CM program has been particularly viewed, and thus the information carried thereby is considered useful for their CM programming later on. The viewing pattern 82d can be derived by detecting the actual starting and ending times of CM program reception for comparison with the scheduled starting and ending times of the CM program known by the program additional information 45. The viewing pattern 82d can indicate information in a manner not restricted to the above.

In the case with the broadcast receiver 2a of the stay-at-home type (FIG. 6), the viewing information 80 is forwarded to the viewing information server 3 via the modem 211, and via the mobile phone section 216 and the antenna 217 in the case with the broadcast receiver 2b of the mobile-type (FIG. 7) (step S97).

The processes in steps S92 to S97 are repeated until the broadcast receiver 2 is through with the operation, or until the end of the broadcast (step S98).

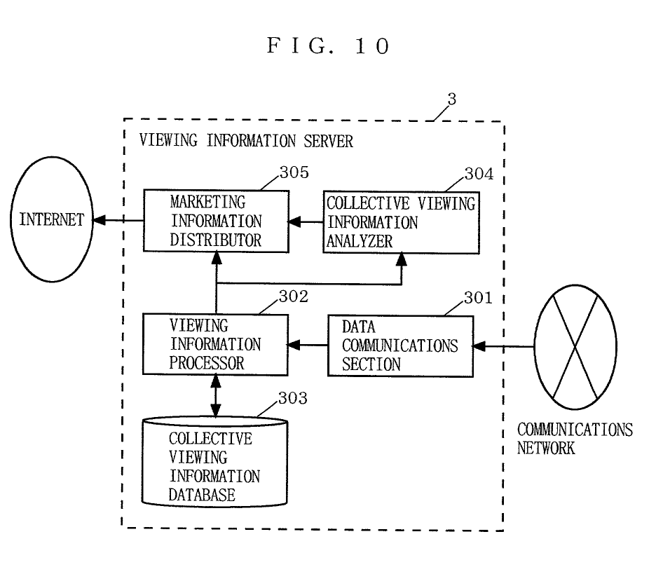

Referring to FIGS. 10 to 12, described next is about the viewing information server 3.

In FIG. 10, the viewing information server 3 includes a data communications section 301, a viewing information processor 302, a collective viewing information database 303, a collective viewing information analyzer 304, and a marketing information distributor 305.

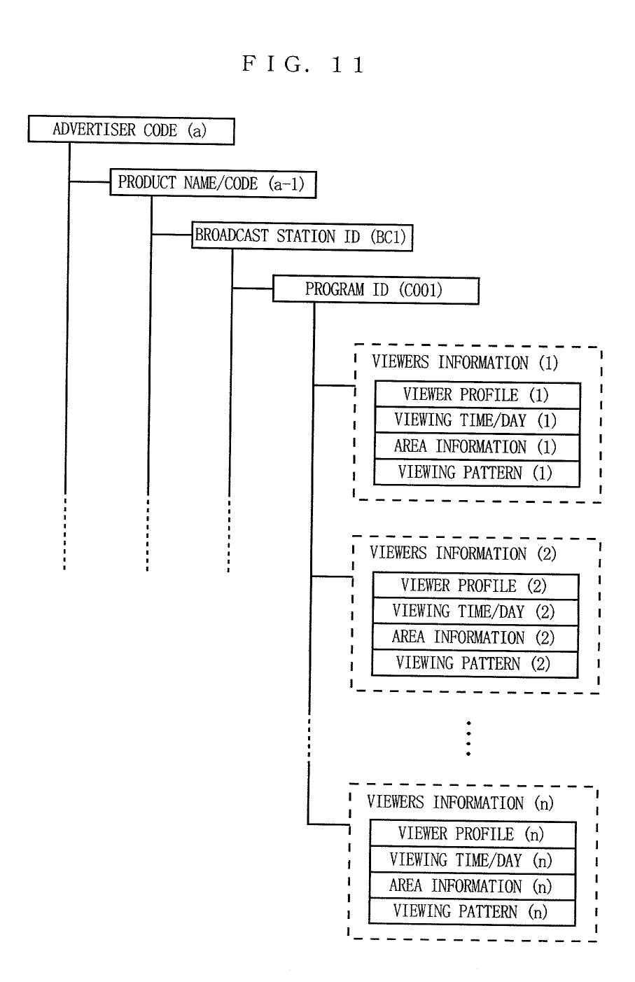

The viewing information 80 coming from the broadcast receiver 2 is received by the data communication section 301. The viewing information processor 302 then uses the viewing information 80 to generate, on an advertiser basis, the collective viewing information for storage into the collective viewing information database 303. Here, the resulting collective viewing information is hierarchically structured as shown in FIG. 11, including a product name/code hierarchy, a broadcast station ID hierarchy, a broadcast program ID hierarchy, and others. The collective viewing information analyzer 304 analyzes and processes thus stored collective viewing information using some statistical techniques, and generates marketing information which is worth knowing. This marketing information is exemplified in FIG. 12, indicating viewership by age and broadcast time. The marketing information distributor 305 forwards, to the advertiser terminal 4 or the broadcast station 1, the marketing information generated in the collective viewing information analyzer 304 at regular intervals, or responding to any request coming from the advertisers and broadcast stations. If necessary, the collective viewing information may be forwarded from the marketing information distributor 305 to the advertiser terminal 4 or the broadcast facility 1.

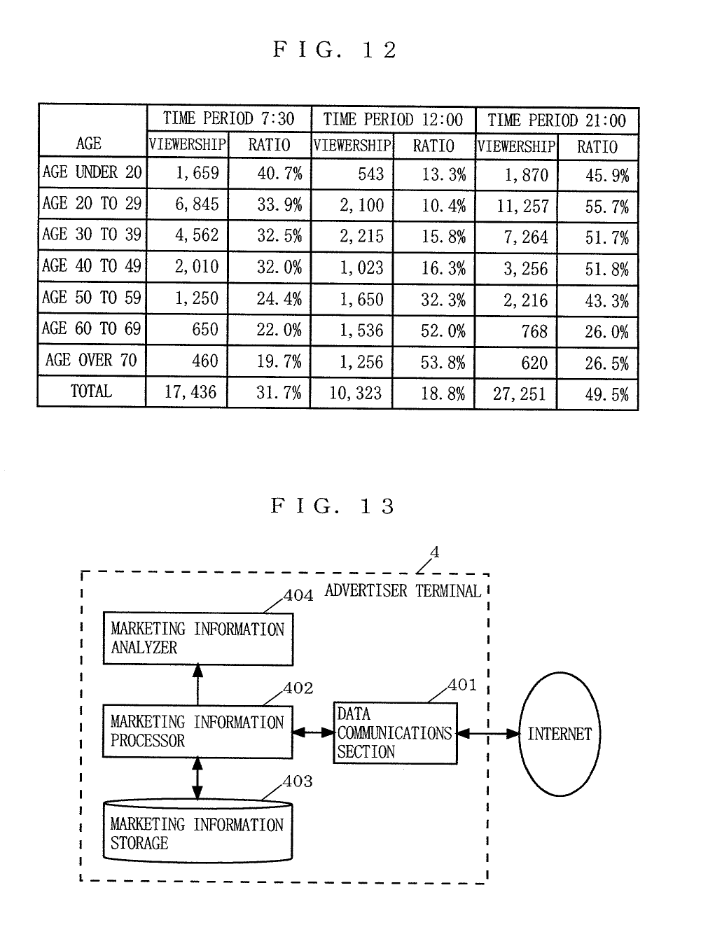

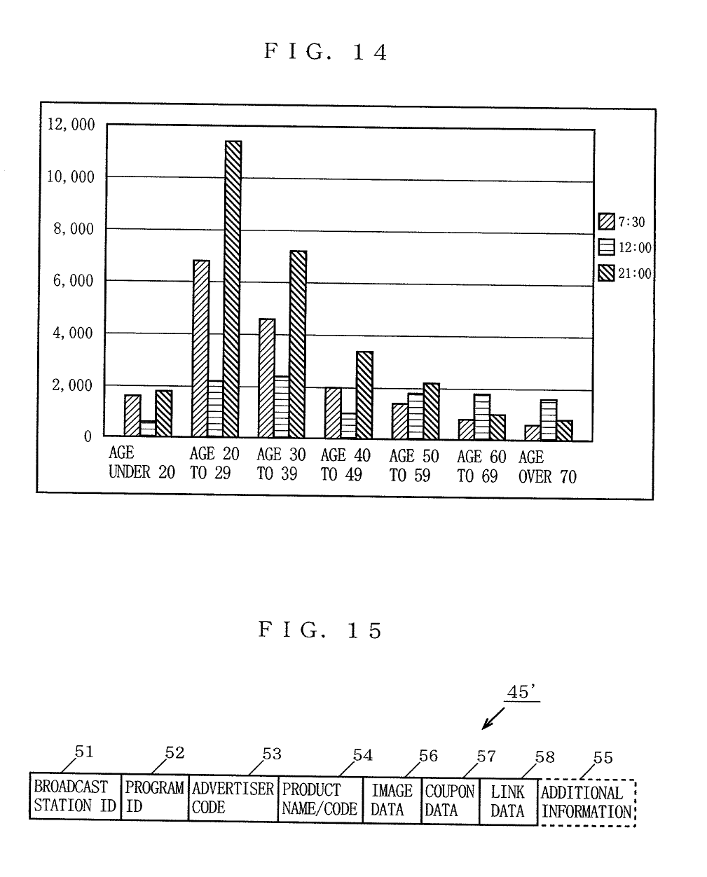

Referring to FIGS. 13 and 14, described lastly is about the advertiser terminal 4.

In FIG. 13, the advertiser terminal 4 includes a data communications section 401, a marketing information processor 402, a marketing information storage 403, and a marketing information analyzer 404.

In the advertiser terminal 4, the marketing information coming from the viewing information server 3 is received by the data communications section 401, and stored in the marketing information storage 403 via the marketing information processor 402. Thus stored marketing information is processed as required, e.g., to create a bar graph of FIG. 14, in the marketing information analyzer 404 at regular intervals, or by the user's operation. The resulting marketing information is used to see the efficacy of running the CM program, management efficacy, and the like.

As such, in the viewing information collection system of the first embodiment, the broadcast station multiplexes the program data 44 and the program additional information 45 of a certain program for broadcasting, and then the viewing information server 3 automatically collects and processes the viewing information 80 composed of the program reception information 81 relating to the broadcast program received by the broadcast receiver 2, and the viewing information 82. With such a structure, the marketing information provided to advertisers and broadcast stations can be useful and helpful as indicating “who viewed what broadcast program when and where”.

Accordingly, the advertisers become able to determine whether their CM programs have been on the air on the appropriate day of the week, broadcast time, broadcast area, and the like, for their target users. On the other hand, the broadcast stations can be provided with data showing correlation between the target users and the CM program broadcast times, and such data is useful and effective for selling broadcast times to advertisers.

(Second Embodiment)

Described in a second embodiment is a viewing information collection system, the marketing information provided by which is useful and effective for advertisers and broadcast stations to a greater degree compared with the viewing information collection system of the first embodiment. This can be achieved by including additionally characteristic information in the viewers information as a part of the viewing information.

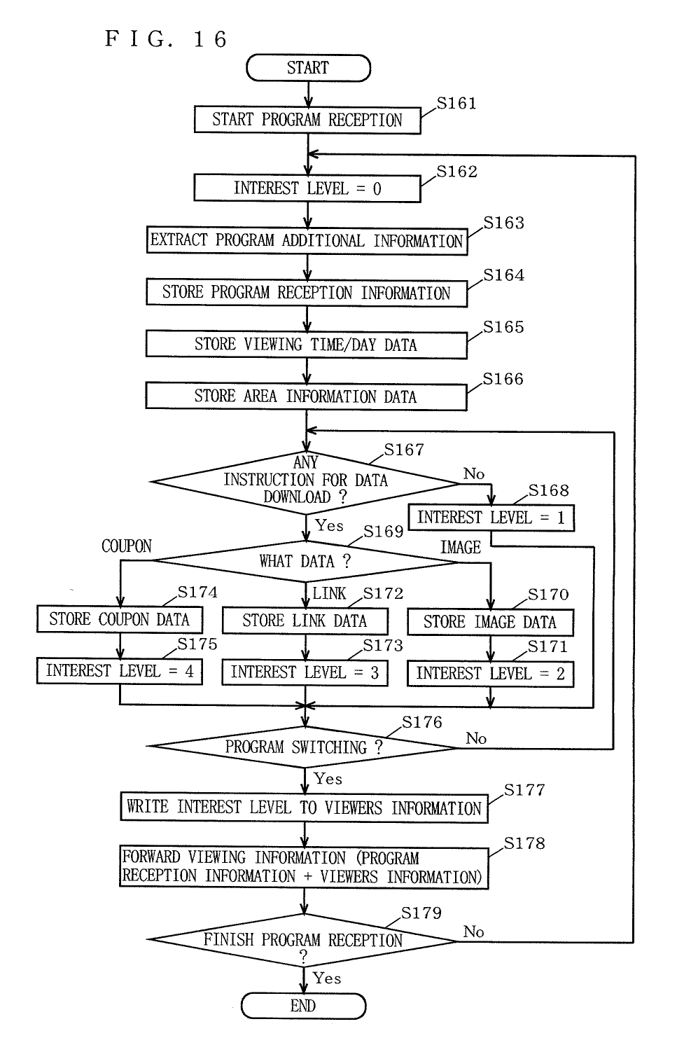

The viewing information collection system of the second embodiment is the same as that of the first embodiment in terms of entire structure and basic operation (FIGS. 1 to 4, 6, 7, 10, and 13). Therefore, in the below, there is no further description about the entire structure and the basic operation of the viewing information collection system of the second embodiment, and only any difference from the viewing information collection system of the first embodiment is provided with reference to FIGS. 15 to 19.

In the second embodiment, the viewers information 82 additionally includes an interest level, specifically indicating how much the viewer got interested in the CM program. This interest level is determined by the broadcast receiver 2 if it has downloaded any data, e.g., image (standard or thumbnail) data of the CM program, coupon data for purchasing the advertising product, link data about a Web server address (URL or password) from which detailed information about the product is available.

Accordingly, compared with the program additional information 45 defining the broadcast station ID 51, the program ID 52, the advertiser code 53, the product name/code 54, and any other additional information 55, program additional information 45′ which is broadcast with the program data 44 further defines image data 56, coupon data 57, and/or link data 58.

The program additional information 45′ in the data broadcast stream 42 is processed by going through the system control section 204, the memory 212, and the storage 213 in the broadcast receiver 2 in accordance with the procedure of FIG. 16.

Referring to FIG. 16, responding to the start of CM program reception (step S161), an interest level in the memory 212 is set (cleared) to “0” in value (step S162) , and the program additional information 45′ associated with the CM program is then extracted from the data broadcast stream 42 (step S163). Then, out of the program additional information 45′, any information needed to be forwarded to the viewing information server 3 is stored in the memory 212 as the program reception information 81 (step S164). Then, into the memory 212, data about viewing time and day coming from the clock 215 provided in the broadcast receiver 2 is stored as the viewing time/day 82b (step S165), and data about the location of the broadcast receiver 2 is stored as the area information 82c (step S166).

After such basic information is stored, steps S167 to S175 are repeated until CM program switching occurs.

Specifically, detected first is whether or not there has been an instruction for data download by monitoring key operation on the key input section 214 (step S167). If there is no such an instruction, it is determined that the viewer showed not that much interest toward the CM program currently on the air, and the interest level is set to “1” (step S168). If there is such an instruction, on the other hand, determined next is what data has been instructed for downloading (step S169). If the instructed data is the image data 56, the image data 56 is accordingly stored in the storage 213 (step S170), and the interest level is then set to “2” because the viewer is determined as being mildly interested in the CM program (step S171). If the instructed data is the link data 58, the link data 58 is accordingly stored in the storage 213 (step S172) , and the interest level is then set to “3” because the viewer is determined as being strongly interested in the CM program (step S173). If the instructed data is the coupon data 57, the coupon data 57 is accordingly stored in the storage 213 (step S174), and the interest level is then set to “4” because the viewer is determined as being very strongly interested in the CM program (step S175).

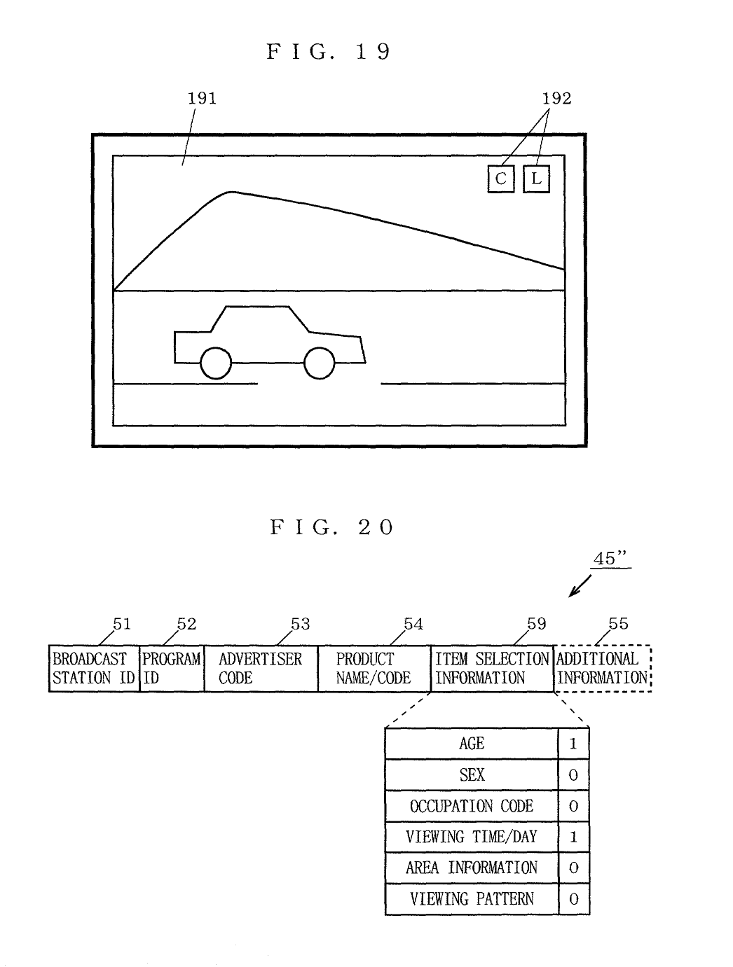

Here, in order to notify the viewer that the program additional information 45′ includes the coupon data 57 and/or the link data 58, as shown in FIG. 19, displaying a data reception indicator(s) 192 on a general broadcast screen 191 may be a possibility.

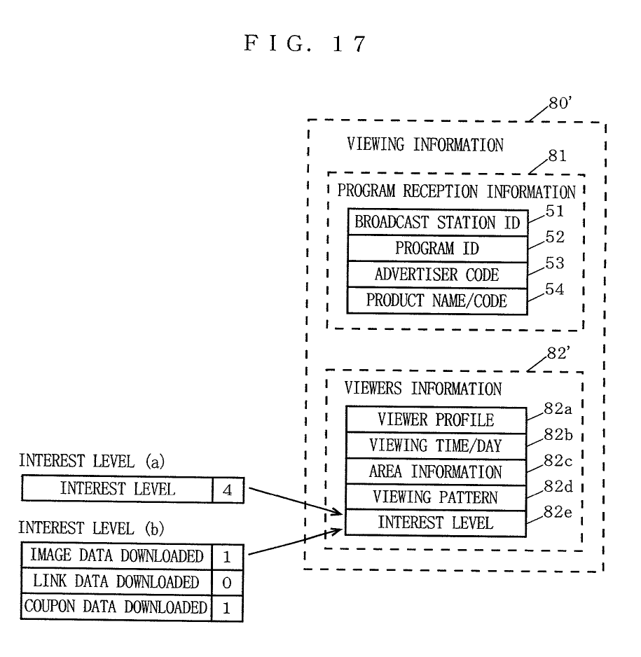

If CM program switching is determined as occurred (step S176, Yes), as shown in FIG. 17, the information so far stored in the memory 212, i.e., the viewer profile 82a, the viewing time/day 82b, the area information 82c, the viewing pattern 82d, and an interest level 82e are packaged into one viewers information 82′ (step S177) . Herein, the interest level 82e may indicate only the highest value (interest level (a) in FIG. 17), or all of the data items so far downloaded (interest level (b) in FIG. 17). Then, the viewers information 82′ and the program reception information 81 are packaged into one viewing information 80′ (step S177).

The viewing information 80′ is forwarded to the viewing information server 3 via the modem 211 if the broadcast receiver 2 is of the stay-at-home type (FIG. 6), and via the mobile phone section 216 and the antenna 217 if of the mobile-type (FIG. 7) (step S178).

The processes in steps S162 to S178 are repeated until the broadcast receiver 2 is through with the operation, or until the end of the broadcast (step S179).

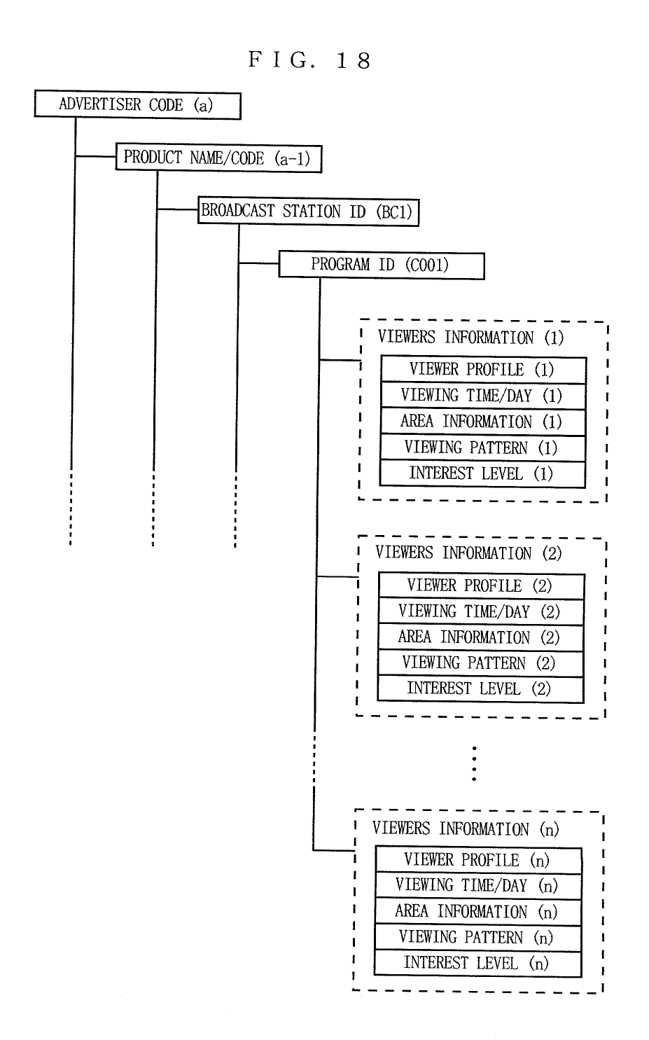

In the viewing information server 3, the viewing information 80′ coming from the broadcast receiver 2 is received by the data communications section 301. The viewing information processor 302 then uses the viewing information 80′ to generate collective viewing information (see FIG. 18) which is hierarchically structured in a given manner, and stores it into the collective viewing information database 303. The collective viewing information analyzer 304 analyzes and processes thus stored collective viewing information to generate marketing information which is worth knowing. This marketing information is forwarded by the marketing information distributor 305 to the advertiser terminal 4 or the broadcast facility 1 at regular intervals, or responding to any request coming from the advertisers and broadcast stations.

As such, the viewing information collection system of the second embodiment automatically collects and processes the viewing information 80 which additionally includes the interest level 82e indicating the viewer's interest toward the CM program. Accordingly, the marketing information provided by such a system is considered useful and effective as is telling “who viewed which CM program when and where with how much interest”. That is, this marketing information surely conveys ratings information, but more than that, is quite usable for advertisers' CM programming and product development, and broadcast stations' broadcast scheduling and broadcast time sales.

Note that, in the case where the downloaded data is the link data 58, the corresponding Web server may be checked whether it has been actually accessed, and if accessed, the interest level 82e may be increased in value. In this case, a limitation may be imposed to restrict the broadcast receivers 2 accessible to the Web server by including in the link data 58 a given password for access permission. This will help to differentiate between viewers who actually viewed the CM program and those who not. Moreover, if the Web server is accessed for product purchase, such information may be managed in connection with the viewing information.

As to the interest level 82e, the viewer himself/herself may make an input as appropriate via operation buttons which are previously provided to the broadcast receiver 2.

(Third Embodiment)

Described in a third embodiment is a viewing information collection system which allows advertisers and broadcast stations to freely select information items out of the viewing information to be collected from the broadcast receivers in the viewing information collection system of the first embodiment.

Such a viewing information collection system of the third embodiment is the same as that of the first embodiment in terms of entire structure and basic operation. Therefore, in the below, there is no further description about the entire structure and the basic operation of the viewing information collection system of the third embodiment, and only any difference from the viewing information collection system of the first embodiment is provided with reference to FIGS. 20 to 23.

In the third embodiment, compared with the program additional information 45 defining the broadcast station ID 51, the program ID 52, the advertiser code 53, the product name/code 54, and any other additional information 55, program additional information 45″ which is broadcast with the program data 44 further defines item selection information 59 indicating what information item is instructed to be collected out of the viewing information 82. Such an instruction is made by setting “1” to any corresponding flag each provided to the information items in the viewing information 82. Here, the flags can be freely set by the advertisers and broadcast stations depending on their purposes for information collection.

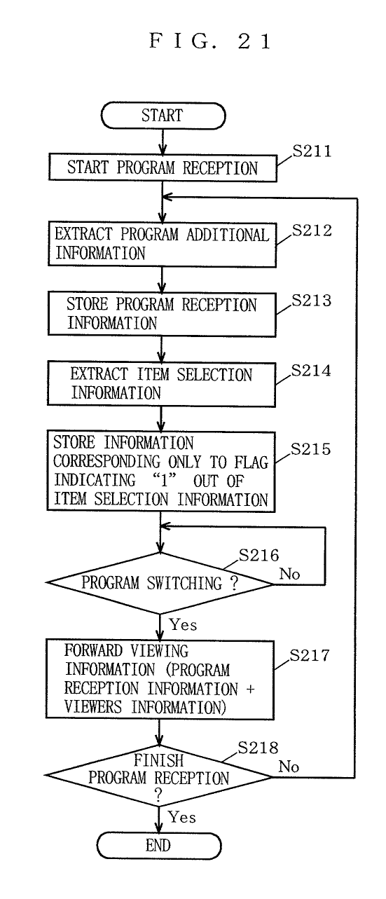

The program additional information 45″ in the data broadcast stream 42 is processed by going through the system control section 204, the memory 212, and the storage 213 in the broadcast receiver 2 in accordance with the procedure of FIG. 21.

Referring to FIG. 21, responding to the start of CM program reception (step S211), the program additional information 45″ associated with the CM program is extracted from the data broadcast stream 42 (step S212). Then, out of the program additional information 45″, any information needed to be forwarded to the viewing information server 3 is stored in the memory 212 as the program reception information 81 (step S213) Then, the item selection information 59 is extracted from the program additional information 45″ (step S214), and then only any information corresponding to flag indicating “1” is stored in the memory 212 (step S215). In the item selection information 59 in FIG. 20 example, the flags of age and viewing time/day are indicating “1”. In this example, stored in the memory 212 is data about the viewer's age included in the viewer profile previously stored in the storage 213, and the viewing time/day coming from the clock 215 provided in the broadcast receiver 2.

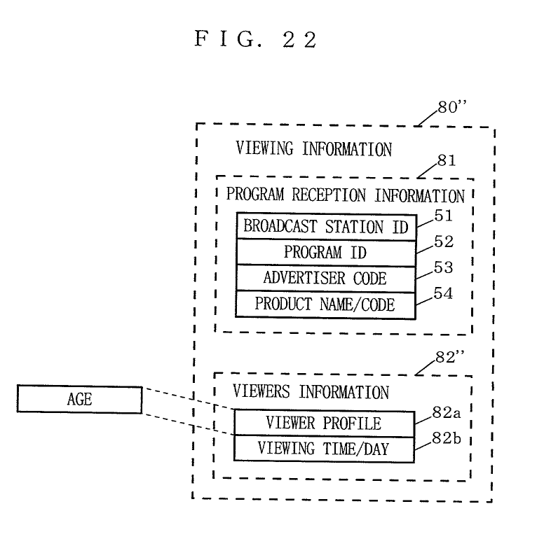

Determined next is whether or not CM program switching has occurred (step S216). If CM program switching is determined as occurred, the information so far stored in the memory 212, i.e., the viewer profile 82a carrying data about the viewer's age only, and the viewing time/day 82b, are packaged into one viewers information 82″ (see FIG. 22). Moreover, the viewers information 82″ and the program reception information 81 are packaged into one viewing information 80″.

The viewing information 80″ is then forwarded to the viewing information server 3 via the modem 211 if the broadcast receiver 2 is of the stay-at-home type (FIG. 6) , and via the mobile phone section 216 and the antenna 217 if of the mobile-type (FIG. 7) (step S217).

The processes in steps S212 to S217 are repeated until the broadcast receiver 2 is through with the operation, or until the end of the broadcast (step S218).

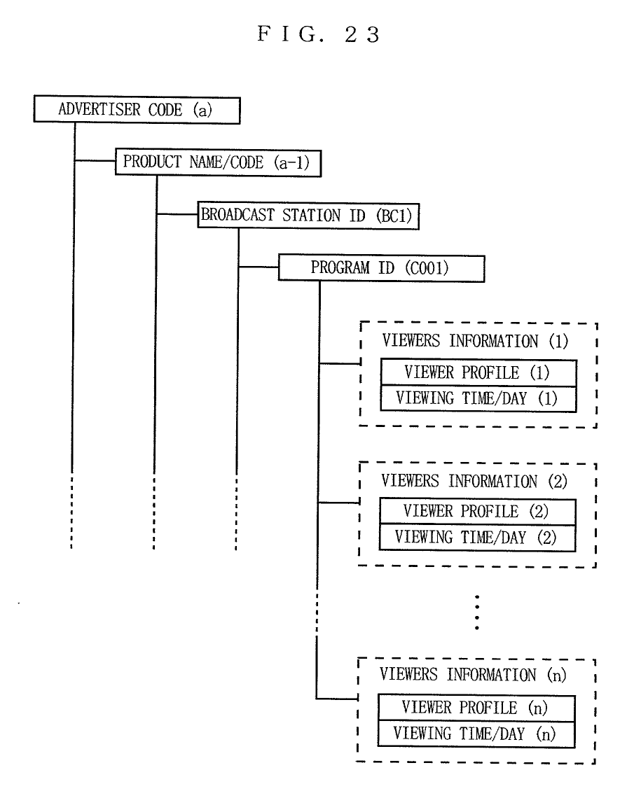

In the viewing information server 3, the viewing information 80″ coming from the broadcast receiver 2 is received by the data communications section 301. The viewing information processor 302 then uses the viewing information 80″ to generate collective viewing information (see FIG. 23) which is hierarchically structured in a given manner, and stores it into the collective viewing information database 303. The collective viewing information analyzer 304 analyzes and processes thus stored collective viewing information using some statistical techniques, and generates marketing information which is worth knowing. This marketing information is forwarded by the marketing information distributor 305 to the advertiser terminal 4 or the broadcast facility 1 at regular intervals, or responding to any request coming from the advertisers and broadcast stations.

As such, in the viewing information collection system of the third embodiment, the program additional information 45″ broadcast by the broadcast station includes the item selection information 59 indicating what information item(s) are instructed to be collected, and based thereon, the viewing information 82″ is forwarded from the broadcast receiver 2 to the viewing information server 3. In such a manner, only needed information item(s) are forwarded from the broadcast receiver 2 to the viewing information server 3. Accordingly, the information amount can be reduced therebetween, successfully leading to effective use of the communications resource of the system, and effective information collection for advertisers.

Here, the viewing information collection system of the second embodiment can surely go through an item selection process based on the item selection information 59.

The item selection information 59 is settable by the program additional information authoring section 103 of the broadcast facility 1. If this is the case, the item selection information 59 may be set by using data coming from any external terminal, e.g., advertiser terminal 4, over the communications network to the program additional information authoring section 103 via the data communications section 110.

Alternatively, through operation of the key input section 214 of the broadcast receiver 2, the viewer may make a selection of the information items for transmission to the viewing information server 3. Especially for privacy protection, the viewing information which is personal as indicating the viewer's age, sex, occupation, and address, is desirably managed with a function provided for refusing data transmission.

In the viewing information collection systems of the first to third embodiments, distributing the marketing information to advertisers and broadcast stations often needs a billing process. In the present embodiment, the viewing information server 3 may be the one going through such a billing process. If so, the viewing information server 3 may manage information about what type of marketing information is provided how many times, and based thereon, go through a process of changing the charge amount.

(Fourth Embodiment)

Described in a fourth embodiment is, by way of example, how the viewing information collected by the viewing information collection systems of the first to third embodiments becomes available for advertisers and broadcast stations.

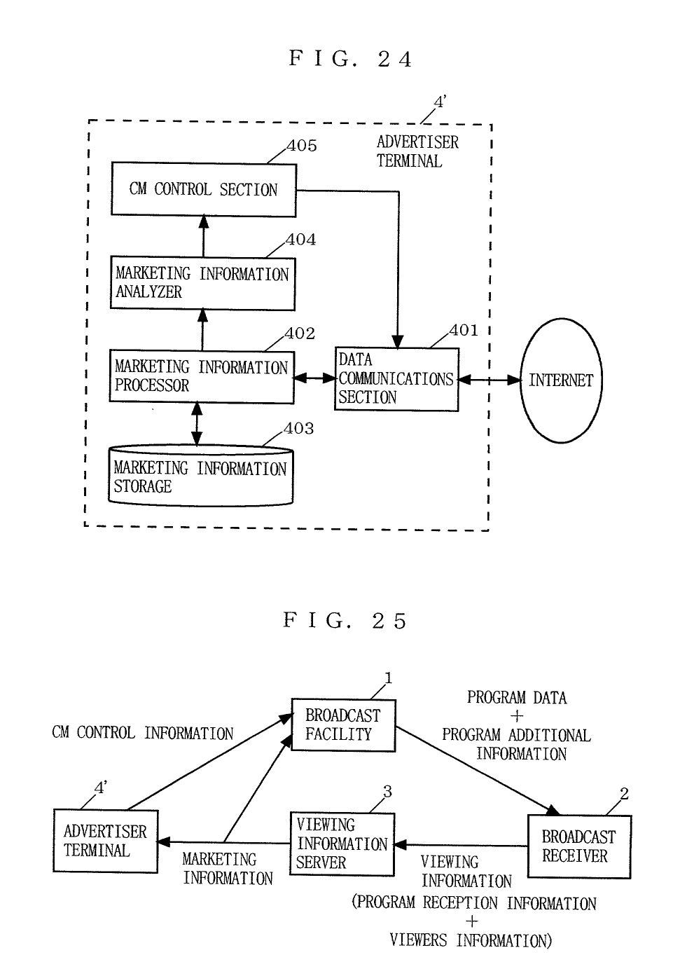

A viewing information collection system of the fourth embodiment is basically the same as those in the first to third embodiments in terms of entire structure and basic operation, but characterized in an advertiser terminal 4′ for its control. In the below, there is no further description about the entire structure and the basic operation of the viewing information collection system of the fourth embodiment, and only the advertiser terminal 4′ is described about its control with reference to FIGS. 24 and 25.

Referring to FIG. 24, the advertiser terminal 4′ includes a data communications section 401, a marketing information processor 402, a marketing information storage 403, a marketing information analyzer 404, and a CM control section 405.

In the advertiser terminal 4′, the data communications section 401 receives marketing information coming from the viewing information server 3, and the marketing information is then stored in the marketing information storage 403 via the marketing information processor 402. Thus stored marketing information is analyzed as required by the marketing information analyzer 404 at regular intervals, or by the user's operation. The resulting marketing information is used to see the efficacy of running the CM program, management efficacy, and the like, and also forwarded to the CM control section 405. After receiving the marketing information, the CM control section 405 goes through analysis to determine whether or not the CM program currently on the air is appropriate in broadcast time for the target viewers, and meeting their tastes and preferences. If determined not appropriate, the CM control section 405 forwards, to the broadcast facility 1 of the broadcast station, CM control information instructing to change the broadcast schedule for the CM program (see FIG. 25). Here, although the CM control section 405 preferably makes such a determination and control automatically in accordance with a given rule, the advertisers may do so manually based on the analysis result.

The CM control information coming from the CM control section 405 is forwarded over the communications network from the data communications section 401 to the broadcast facility 1 of the broadcast station. On the broadcast facility 1 side, the broadcast schedule manager 105 is the one receiving the CM control information coming from the advertiser terminal 4′ via the data communications section 110. Then, based on the CM control information, the broadcast schedule manager 105 changes the broadcast schedule for the CM program.

Under such control, the broadcast schedule can be changed as follows. Referring to FIG. 14 example, the analysis result shows that, among three broadcast time periods classified as 7:30, 12;00, and 21:00, the ratings in the 12:00 time period of the age group under 40 are significantly low. Therefore, the CM programs currently on the air during the 12:00 time period targeting the age group may be replaced with those targeting the age group over 50, whose ratings in the 12:00 time period is high.

Instead of focusing on the broadcast time periods to change the broadcast schedule, interrelating the viewing information of a certain CM program to that of other broadcast programs, i.e., substantial or CM programs, preceding and subsequent thereto is a possibility. In such a case, the broadcast schedule can be changed with pinpoint accuracy. For example, a certain CM program and its proceeding and subsequent broadcast programs are broadcast over the same channel, it means that the viewer stayed tuned to the channel, leading to a conclusion that there is no need to change the broadcast schedule because the target viewership has been correct. On the other hand, if those broadcast programs are not broadcast over the same channel, it means that the viewer changed the channels, leading to a conclusion that there needs to change the broadcast schedule because the target viewership has been wrong. Here, interrelating the viewing information as such may be done by the broadcast receiver 2 (when the viewing information is forwarded) or by the viewing information server 3 (when the viewing information is processed).

As such, the viewing information collection system of the fourth embodiment, the viewing information 80, i.e., marketing information, is used as a basis to change the broadcast schedule. Therefore, the viewers' response to the CM program can be directly and swiftly reflected to CM programming.

(Fifth Embodiment)

In a fifth embodiment, described is a viewing information collection system which enables viewers' product purchase using the program additional information, and concurrently, collection of the viewing information relating to CM programs.

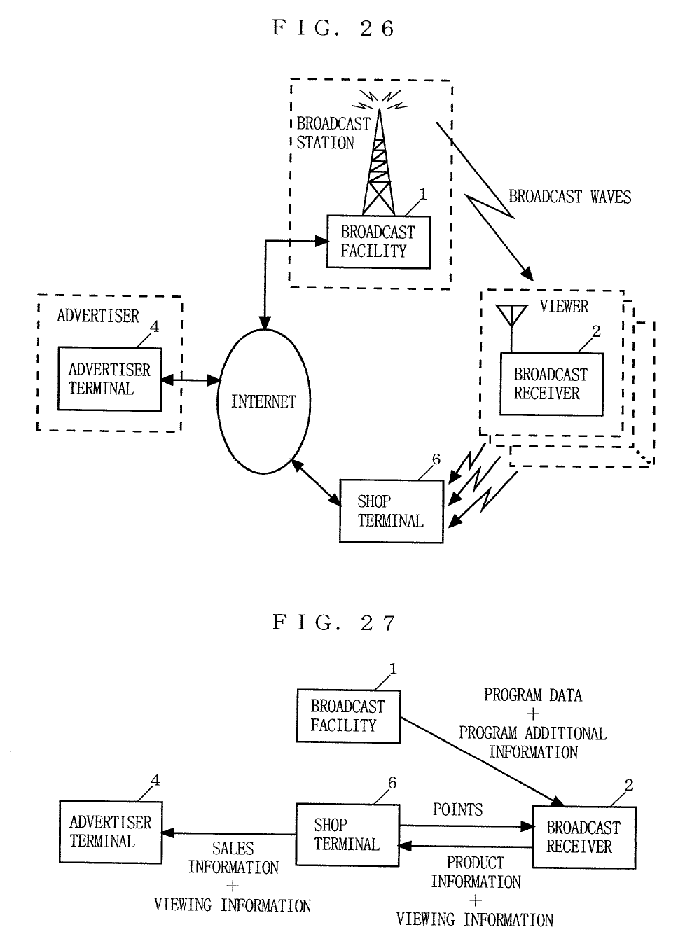

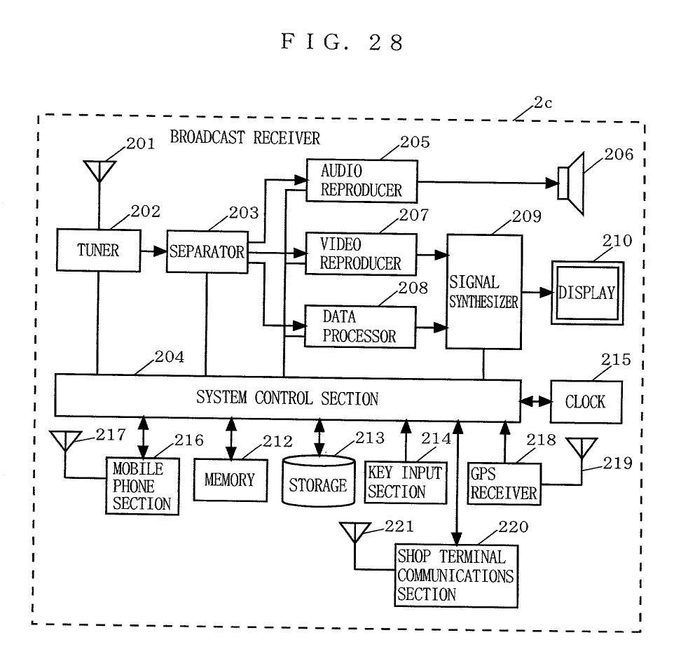

Referring to FIGS. 26 and 27, the entire structure of such a viewing information collection system of the fifth embodiment is briefly described.

In FIG. 26, the viewing information collection system of the fifth embodiment includes the broadcast facility 1 provided in a broadcast station, a viewer's broadcast receiver 2, a shop terminal 6 provided in a shop at which the advertising product is available, and the advertiser terminal 4 belonging to the advertiser who puts the CM program. As shown in FIG. 26, the viewing information collection system of the fifth embodiment includes a shop terminal 6 as an alternative to the viewing information server 3 in the viewing information collection systems of the first to third embodiments. That is, in the viewing information collection system of the fifth embodiment, the viewing information is not always collected via the viewing information server 3, but only when the advertising product is sold at the shop, i.e., through the shop terminal 6 (see FIG. 27).

In the below, referring to FIGS. 28 to 31, the viewing information collection system of the fifth embodiment is described focusing on any difference from those of the first to third embodiments.

Compared with the program additional information 45 defining the broadcast station ID 51, the program ID 52, the advertiser code 53, the product name/code 54, and any other additional information 55, as shown in FIG. 15, program additional information 45′ which is broadcast with the program data 44 further defines, at least, either the image data 56 or the coupon data 57. Here, the image data 56 and the coupon data 57 each include product information, e.g., product type, for specifying what product is advertised in the CM program.

In order to receive the broadcast waves including such program additional information 45′, a broadcast receiver 2c of a mobile type shown in FIG. 28 is applicable. Here, compared with the broadcast receiver 2b of FIG. 7, the broadcast receiver 2c of FIG. 28 further includes a shop terminal communications section 220, and an antenna 221.

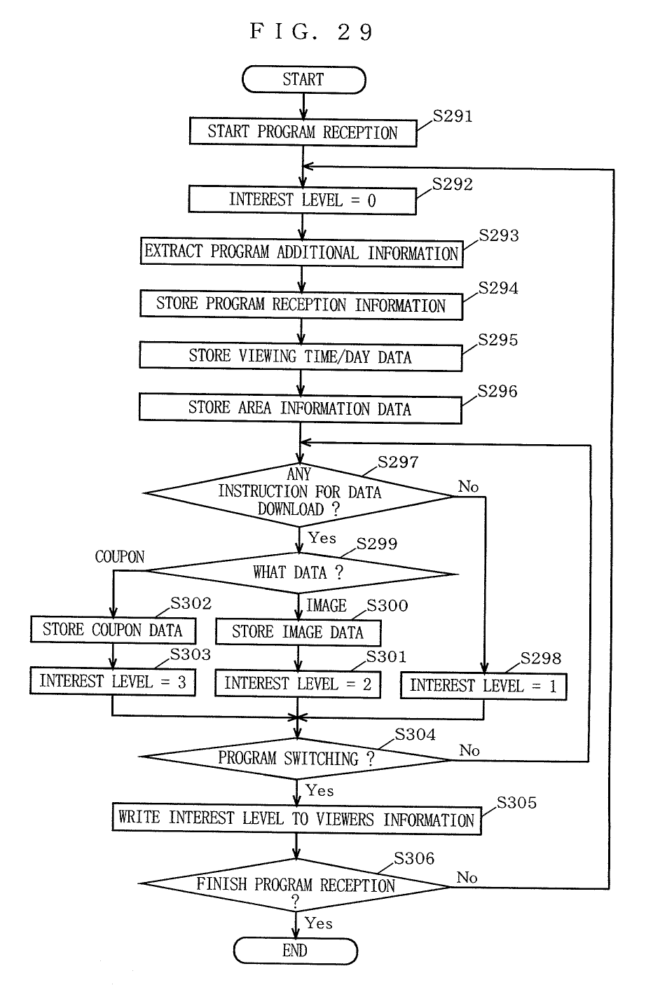

The program additional information 45′ in the data broadcast stream 42 is processed by going through the system control section 204, the memory 212, and the storage 213 in the broadcast receiver 2c in accordance with the procedure of FIG. 29.

In FIG. 29, responding to the start of CM program reception (step S291) , an interest level in the memory 212 is set (cleared) to “0” in value (step S292), and the program additional information 45′ associated with the CM program is then extracted from the data broadcast stream 42 (step S293). Then, out of the program additional information 45′, any needed information is stored in the memory 212 as the program reception information 81 (step S294). Then, into the memory 212, data about viewing time and day coming from the clock 215 provided in the broadcast receiver 2c is stored as the viewing time/day 82b (step S295) and data about the location of the broadcast receiver 2c is stored as the area information 82c (step S296).

After such basic information is stored, steps S297 to S303 are repeated until CM program switching occurs.

Specifically, detected first is whether or not there has been an instruction for data download by monitoring key operation on the key input section 214 (step S297). If there is no such an instruction, it is determined that the viewer showed not that much interest toward the CM program currently on the air, and the interest level is set to “1” (step S298). If there is such an instruction, on the other hand, determined next is what data has been instructed for downloading (step S299). If the instructed data is the image data 56, the image data 56 is accordingly stored in the storage 213 (step S300), and the interest level is then set to “2” because the viewer is determined as being mildly interested in the CM program (step S301) . If the instructed data is the coupon data 57, the coupon data 57 is accordingly stored in the storage 213 (step S302) , and the interest level is then set to “3” because the viewer is determined as being strongly interested in the CM program (step S303).

If CM program switching is determined as occurred (step S304, Yes) , as shown in FIG. 17, the information so far stored in the memory 212, i.e., the viewer profile 82a, the viewing time/day 82b, the area information 82c, the viewing pattern 82d, and the interest level 82e are packaged into one viewers information 82′. Also, the viewers information 82′ and the program reception information 81 are packaged into one viewing information 80′ (step S305).

The processes in steps S292 to S305 are repeated until the broadcast receiver 2c is through with the operation, or until the end of the broadcast (step S306).

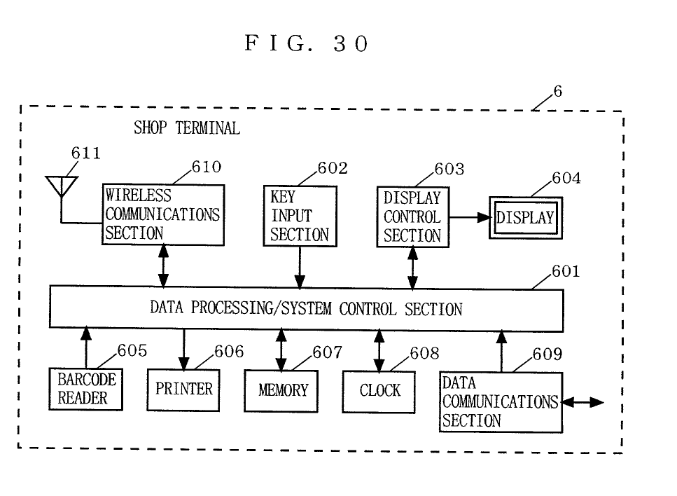

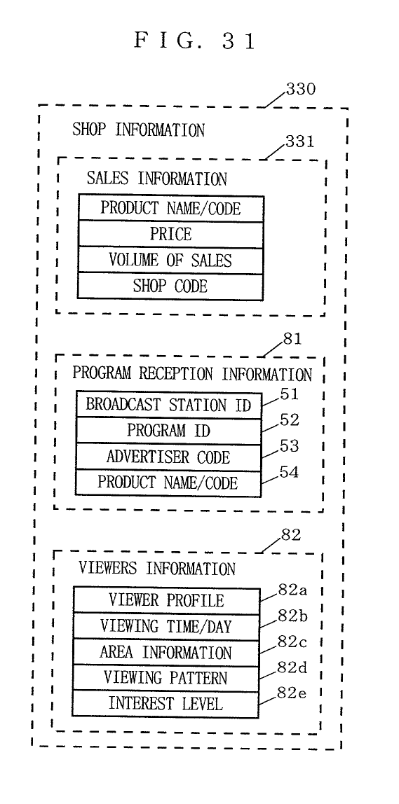

Next, referring to FIGS. 30 and 31, described is about the shop terminal 6.

In FIG. 30, the shop terminal 6 includes a data processing/system control section 601, a key input section 602, a display control section 603, a display 604, a barcode reader 605, a printer 606, a memory 607, a clock 608, a data communications section 609, a wireless communications section 610, and an antenna 611.

The data processing/system control section 601 comprehensively controls the shop terminal 6, and is also in charge of data processing. The key input section 602 is used to input product codes, prices, and others. The display 604 displays thus inputted product names, prices, and others. The display control section 603 controls the display 604. The barcode reader 605 is used to read barcodes on the products. The printer 606 is used to print out, on papers, the product names, prices, and others. The memory 607 stores data for data processing and system control. The data communications section 609 is used for communications with outside. The wireless communications section 610 wirelessly communicates with the broadcast receiver 2c using Bluetooth, infrared ray, and the like.

In the case where the viewer wants to purchase the advertising product in the CM program, he/she downloads the image data 56 or the coupon data 57 to the broadcast receiver 2c. Then, the viewer brings the broadcast receiver 2c now carrying the downloaded data to the corresponding shop where the shop terminal 6 is provided. For product purchase, the following processes are to be executed.

First, the broadcast receiver 2c is wirelessly connected to the shop terminal 6 by means of the shop terminal communications section 220 and the wireless communications section 610. After establishing such a connection, the viewer operates the key input section 214 on the broadcast receiver 2c so as to read from the storage 213 the image data 56 or the coupon data 57 whichever downloaded, and forwards it to the shop terminal 6. Thereby, the viewer is authenticated based on viewer authentication data which is previously stored in the broadcast receiver 2c, and the product is specified by product information included in the forwarded data. Together with the image data 56 or the coupon data 57, forwarded to the shop terminal 6 is the viewing information 80′ which is stored and processed at the time of CM program reception. In accordance with those data and information, the data processing/system control section 601 of the shop terminal 6 goes through processes similarly to the general types of shop terminals (so-called POS) to input prices, payment selection, and others. At the same time, as shown in FIG. 31, the resulting sales information 331 is packaged together with the viewing information 80′ to store it as shop information 330 into the memory 607 of the shop terminal 6. On the other hand, the shop terminal 6 forwards, to the broadcast receiver 2c, the number of points corresponding to the product purchase induced by the CM program.

The shop information 330 stored in the shop terminal 6 is forwarded to the advertiser terminal 4 or the broadcast facility 1 through the data communications section 609 at regular intervals, or responding to any request coming from advertisers and broadcast stations.

Note here that the shop terminal 6 and the broadcast receiver 2c can surely communicate with each other through a cable if the wireless communications section 610 and the antenna 611 of the shop terminal 6, and the shop terminal communications section 220 and the antenna 221 of the broadcast receiver 2c are changed in structure applicable to interface for the purpose.

As such, in the viewing information collection system of the fifth embodiment, linking the shop terminal 6 to the broadcast receiver 2c allows the users to view CM programs, support the users′ product purchase behavior through the medium of product information downloaded to the broadcast receiver 2c, and perform user authentication for payment. Further, the single terminal can successively collect various kinds of information about the viewers. Accordingly, the viewing information indicating “who viewed which CM program when and where with how much interest”, and the shop information indicating “which product is sold how many and how much at which shop” can be associated together, making the resulting marketing information more worth knowing.

Further, to purchase advertising products, all the viewers have to do is to show either the image data 56 or the coupon data 57 downloaded from the CM program at the shop. Accordingly, they do not bother to shop around to buy the product.

(Sixth Embodiment)

Described in a sixth embodiment is a viewing information collection system for collecting, without using the viewing information server, the viewing information based on the viewers′ accesses to a Web server from which information relating to the CM program is available.

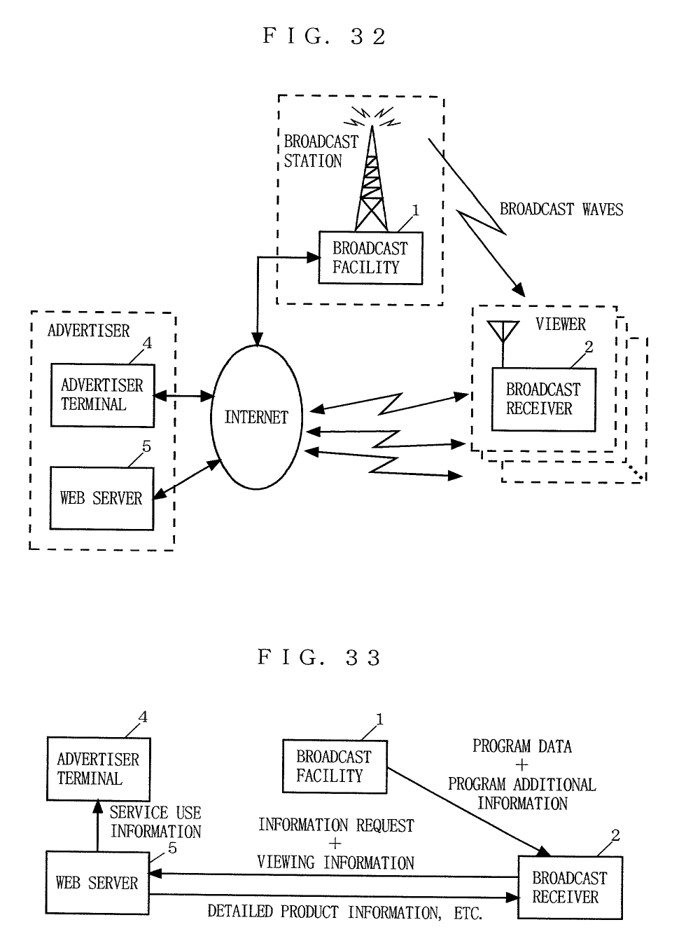

Referring to FIGS. 32 and 33, the entire structure of such a viewing information collection system of the sixth embodiment is briefly described.

In FIG. 32, the viewing information collection system of the sixth embodiment includes the broadcast facility 1 provided in a broadcast station, a viewer's broadcast receiver 2, the advertiser terminal 4 belonging to an advertiser who puts the CM program, and a Web server 5. As shown in FIG. 32, unlike the viewing information collection systems of the first to third embodiments, the viewing information collection system of the sixth embodiment includes no viewing information server 3, but includes the Web server 5 on the advertiser side. That is, in the viewing information collection system of the sixth embodiment, the viewing information is not always collected through the viewing information server 3, but only when the viewer accesses the Web server 5 (see FIG. 33).

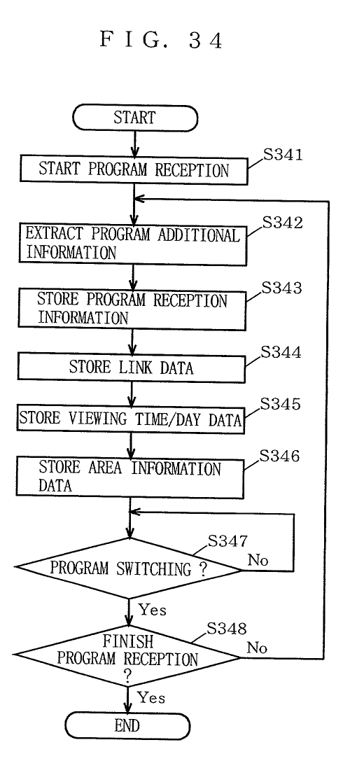

In the below, referring to FIGS. 34 to 36, the viewing information collection system of the sixth embodiment is described focusing on any difference from those of the first to third embodiments.

Compared with the program additional information 45 defining the broadcast station ID 51, the program ID 52, the advertiser code 53, the product name/code 54, and any other additional information 55, as shown in FIG. 15, the program additional information 45′ which is broadcast with the program data 44 further defines, at least, the link data 58.

The program additional information 45′ in the data broadcast stream 42 is processed by going through the system control section 204, the memory 212, and the storage 213 in the broadcast receiver 2 in accordance with the procedure of FIG. 34.

Referring to FIG. 34, responding to the start of CM program reception (step S341), the program additional information 45′ associated with the CM program is extracted from the data broadcast stream 42 (step S342). Then, out of the program additional information 45′, any needed information is stored in the memory 212 as the program reception information 81 (step S343). At this time, the link data 58 in the program additional information 45′ is stored in the storage 213 (step S344) . Then, into the memory 212, data about viewing time and day coming from the clock 215 provided in the broadcast receiver 2 is stored as the viewing time/day 82b (step S345), and data about the location of the broadcast receiver 2 is stored as the area information 82c (step S346).

Determined next is whether or not CM program switching has occurred (step S347). If determined Yes, the processes in steps S342 to S347 are repeated until the broadcast receiver 2 is through with the operation, or until the end of the broadcast (step S348).

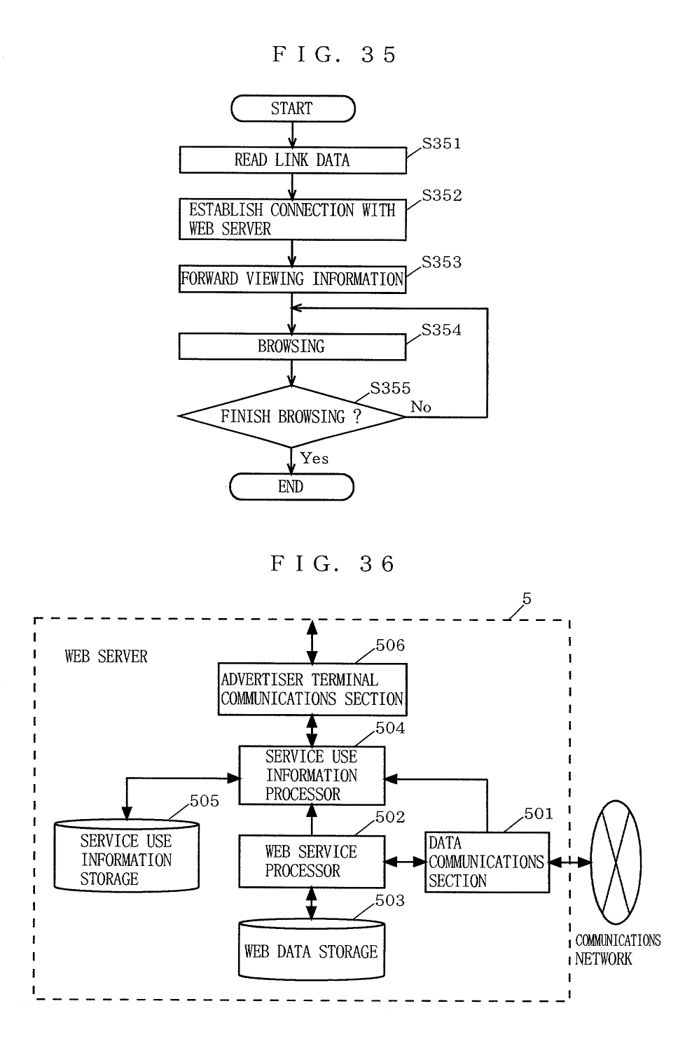

Referring to FIG. 35, described next is the operation of the broadcast receiver 2 in a case where the viewer shows his/her interest toward the CM program, and decides to access the Web server 5 for detailed information.

In FIG. 35, if receiving an instruction to access the Web server 5 through the key input section 214, the broadcast terminal 2 reads the link data 58 from the storage 213 (step S351). Then, the broadcast receiver 2 uses the modem 211 (the case of FIG. 6), or the mobile phone section 216 and the antenna 217 (the case of FIG. 7) for connection with the Web server 5 over the Internet (step S352). In response, the viewing information 80′ which is stored and processed at the time of CM program reception is forwarded to the Web server 5 (step S353) Then, until disconnection, the viewer goes on Web browsing while operating as appropriate (steps S354, S355).

Referring to FIG. 36, described next is about the Web server 5.

In FIG. 36, the Web server 5 includes a data communications section 501, a Web service processor 502, a Web data storage 503, a service use information processor 504, a service use information storage 505, and an advertiser terminal communications section 506.

The data communications section 501 is provided for connection between, over the Internet, the Web server 5 and the broadcast receiver 2. The viewing information 80′ coming from the broadcast receiver 2 right after such a connection is established is temporarily stored in the service use information storage 505 via the service use information processor 504. Then, responding to browsing performed by the broadcast receiver 2, the data communications section 501 forwards thereto Web data stored in the Web data storage 503 over the Internet so that the Web service processor 502 offers various services to the viewer.

After a series of services for the broadcast receiver 1 2 are through, the service use history is packaged by the service use information processor 504 with the viewing information 80′, and the resulting information is stored in the service use information storage 505 as service use information. This service use information is forwarded to the marketing information processor 402 of the advertiser terminal 4 via the advertiser terminal communications section 506 at regular intervals, or responding to any instruction coming from the advertiser terminal 4.

As such, the viewing information collection system of the sixth embodiment becomes able to collect, without using the viewing information server, information about the viewers who showed strong interest toward the CM program through the linkage of the broadcast receiver 2 and the Web server 5. Accordingly, information about “who viewed which CM program when and where” can be directly associated with information telling that the specific viewers have accessed the Web server with strong interest, making the resulting marketing information more worth knowing. Further, with no viewing information server provided, the advertisers can independently collect the viewing information.

Note here that, if the advertiser is engaged in Electronic Commerce (EC) on the Web server 5, similarly in the fifth embodiment, a series of processes relating to the users' viewing CM programs and product purchase behaviors, and user authentication for payment can be executed on the Web.

While the invention has been described in detail, the foregoing description is in all aspects illustrative and not restrictive. It is understood that numerous other modifications and variations can be devised without departing from the scope of the invention.

What is claimed is:

1. A viewing information collection system utilizing a broadcast environment in which a value added service is provided through data broadcasting, said system comprising:
a broadcast facility operable to generate program data composed of video information and audio information of a broadcast program, and program additional information associated with the broadcast program, and using data broadcasting, broadcast the program additional information together with the program data;
a broadcast receiver which is provided plurally and operable to receive said program data and said program additional information of the program, according to a viewer's selection, and automatically generate and transmit viewing information which is a combination of program reception information partially or entirely extracted from the program additional information specifying the broadcast program, and viewers information about the viewer; and
a viewing information server operable to receive said viewing information transmitted from each of said broadcast receivers, analyze and process the viewing information to generate marketing information meeting a broadcast program provider's needs, and sends out the resulting marketing information to the broadcast program provider.

2. The viewing information collection system according to claim 1, wherein said broadcast receiver transmits said generated viewing information to said viewing information server at the end of viewing the broadcast program.

3. The viewing information collection system according to claim 1, wherein said broadcast receiver transmits said generated viewing information to said viewing information server after storage of a predetermined period of time.

4. The viewing information collection system according to claim 1, wherein said viewing information server is limited in number to one to solely collect and manage said viewing information.

5. The viewing information collection system according to claim 1, wherein two or more of said viewing information server are provided to each independently collect and manage said viewing information.

6. The viewing information collection system according to claim 1, wherein said program additional information at least includes a unit of information for specification of a broadcast station, a broadcast program, an advertiser, or a product.

7. The viewing information collection system according to claim 1, wherein said viewers information includes a unit of information indicating day and time when the viewer viewed the broadcast program.

8. The viewing information collection system according to claim 1, wherein said viewers information includes at least a unit of information about the viewer's age, sex, occupation, or preference.

9. The viewing information collection system according to claim 1, wherein said viewers information includes a unit of information indicating an area in which the viewer viewed the broadcast program.

10. The viewing information collection system according to claim 1, wherein said viewers information includes viewing pattern information indicating which part of the broadcast program is viewed by the viewer.

11. The viewing information collection system according to claim 1, wherein said program additional information includes at least one of image data available in the broadcast program, coupon data usable to purchase a product advertised in the broadcast program, and link data to access a Web server from which detailed information about the broadcast program is available.

12. The viewing information collection system according to claim 11, wherein said broadcast receivers can be restricted to access the Web server by including in said link data a predetermined password for access permission.

13. The viewing information collection system according to claim 1, wherein said viewers information includes interest level indicating how much interest the viewer showed toward the broadcast program.

14. The viewing information collection system according to claim 11, wherein said viewers information includes interest level indicating how much interest the viewer showed toward the broadcast program.

15. The viewing information collection system according to claim 14, wherein said broadcast receiver changes said interest level between a case of acquiring any one of said image data of the broadcast program, said coupon data thereof, and said link data thereof, and a case where the viewer merely viewed the broadcast program.

16. The viewing information collection system according to claim 14, wherein said broadcast receiver changes said interest level among cases of acquiring said image data of the broadcast program, acquiring said coupon data thereof, and acquiring said link data thereof, and a case where the viewer merely viewed the broadcast program.

17. The viewing information collection system according to claim 14, wherein said interest level is inputted to said broadcast receiver by the viewer.

18. The viewing information collection system according to claim 15, wherein when acquiring said link data, said broadcast receiver changes said interest level by determining whether the corresponding Web server is actually accessed.

19. The viewing information collection system according to claim 1, wherein said program additional information is provided with item selection information indicating what information item the broadcast program provider is wanting to collect out of said viewers information, and the viewers information sent out from said broadcast receiver to said viewing information server includes only the information item indicated by the item selection information.

20. The viewing information collection system according to claim 1, wherein said broadcast receiver forwards, to said viewing information server, said viewers information including only information item previously selected and set to the broadcast receiver by the viewer.

21. The viewing information collection system according to claim 1, wherein the broadcast program provider of a CM program provided with said marketing information analyzes a correlation between a targeting viewership and a broadcast time, and if the correlation is not considered optimal, said broadcast facility controls a broadcast schedule for the CM program based on an optimizing instruction coming from the broadcast program provider.

22. A viewing information collection system utilizing a broadcast environment in which a value added service is provided through data broadcasting, said system comprising:
a broadcast facility operable to generate program data composed of video information and audio information of a broadcast program, and program additional information associated with the broadcast program, and using data broadcasting, broadcast the program additional information together with the program data;
a broadcast receiver which is provided plurally and operable to receive said program data and said program additional information of the program, according to a viewer's selection, and automatically generate and store viewing information which is a combination of program reception information partially or entirely extracted from the program additional information specifying the broadcast program, and viewers information about the viewer; and
a shop terminal operable to receive said viewing information from said broadcast receiver to allow the viewer to purchase a product advertised in a CM program, and analyze and process the viewing information to generate shop information meeting a broadcast program provider's needs, and sends out the resulting shop information to the broadcast program provider.

23. The viewing information collection system according to claim 22, wherein said program additional information includes at least either image data available in the CM program or coupon data usable to purchase the product advertised in the CM program, and said image data or said coupon data is transmitted from said broadcast receiver to said shop terminal to know what product the viewer is wanting to purchase.

24. A viewing information collection system utilizing a broadcast environment in which a value added service is provided through data broadcasting, said system comprising:
a broadcast facility operable to generate program data composed of video information and audio information of a broadcast program, and program additional information which is associated with the broadcast program and including link data to access a Web server from which detailed information about the broadcast program is available, and using data broadcasting, broadcast the program additional information together with the program data;
a broadcast receiver which is provided plurally and operable to receive said program data and said program additional information of the program, according to a viewer's selection, and automatically generate and store said link data, and viewing information which is a combination of program reception information partially or entirely extracted from the program additional information specifying the broadcast program, and viewers information about the viewer; and
a Web server operable to provide a service according to an access by each of said broadcast receivers using said link data, and when accessed, receive said viewing information, analyze and process the viewing information to generate service use information meeting a broadcast program provider's needs, and sends out the resulting service use information to the broadcast program provider.

25. A broadcast receiver operable to receive program data composed of video information and audio information of a broadcast program, and program additional information associated with the broadcast program which are both broadcast from a broadcast facility using data broadcasting, said broadcast receiver comprising:
a reception section operable to receive said program data and said program additional information of the program according to a viewer's selection;
a generation section operable to automatically generate viewing information which is a combination of program reception information partially or entirely extracted from said program additional information specifying the broadcast program, and viewers information about the viewer; and
a transmission section operable to transmit said viewing information to a viewing information server operable to generate marketing information analyzed and processed to meet a broadcast program provider's needs, and sends out the resulting marketing information to the broadcast program provider.

26. The broadcast receiver according to claim 25, wherein said generated viewing information is transmitted to said viewing information server at the end of viewing the broadcast program.

27. The broadcast receiver according to claim 25, wherein said generated viewing information is transmitted to said viewing information server after storage of a predetermined time period.

28. The broadcast receiver according to claim 25, wherein said viewers information includes a unit of information indicating day and time when the viewer viewed the broadcast program.

29. The broadcast receiver according to claim 25, wherein said viewers information includes at least a unit of information about the viewer's age, sex, occupation, or preference.

30. The broadcast receiver according to claim 25, wherein said viewers information includes a unit of information indicating an area in which the viewer viewed the broadcast program.

31. The broadcast receiver according to claim 25, wherein said viewers information includes viewing pattern information indicating which part of the broadcast program is viewed by the viewer.

32. The broadcast receiver according to claim 25, wherein said viewers information includes interest level indicating how much interest the viewer showed toward the broadcast program.

33. The broadcast receiver according to claim 32, wherein, when said program additional information includes at least one of image data available in the broadcast program, coupon data usable to purchase a product advertised in the broadcast program, and link data to access a Web server from which detailed information about the broadcast program is available,
said interest level is changed between a case of acquiring any one of said image data of the broadcast program, said coupon data thereof, and said link data thereof, and a case where the viewer viewed the broadcast program.

34. The broadcast receiver according to claim 32, wherein, when said program additional information includes image data available in the broadcast program, coupon data usable to purchase a product advertised in the broadcast program, and link data to access a Web server from which detailed information about the broadcast program is available,
said interest level is changed among cases of acquiring said image data of the broadcast program, acquiring said coupon data thereof, and acquiring said link data thereof, and a case where the viewer viewed the broadcast program.

35. The broadcast receiver according to claim 32, wherein said interest level is inputted to said broadcast receiver by the viewer.

36. The broadcast receiver according to claim 33, wherein, in response to acquisition of said link data, said interest level is changed by determining whether the corresponding Web server is actually accessed.

37. The broadcast receiver according to claim 25, wherein said viewers information sent out to said viewing information server includes only the information item indicated by the item selection information which is a part of said program 5 additional information and indicating what information item the broadcast program provider is wanting to collect out of said viewers information.

38. The broadcast receiver according to claim 25, wherein said viewers information sent out to said viewing information server includes only information item previously selected and set by the viewer.

39. A broadcast receiver operable to receive program data composed of video information and audio information of a broadcast program, and program additional information associated with the broadcast program which are both broadcast from a broadcast facility using data broadcasting, said broadcast receiver comprising:
a reception section operable to receive said program data and said program additional information of the program according to a viewer's selection;
a generation section operable to automatically generate viewing information which is a combination of program reception information partially or entirely extracted from said program additional information specifying the broadcast program, and viewers information about the viewer; and
a transmission section operable to transmit said viewing information to a shop terminal operable to enable the viewer's product purchase, generate shop information which is analyzed and processed to meet a broadcast program provider's needs, and sends out the resulting shop information to the broadcast program provider.

40. The broadcast receiver according to claim 39, wherein, when said program additional information includes at least either image data available in the CM program, or coupon data usable to purchase a product advertised in the CM program,
said image data or said coupon data is transmitted to said shop terminal to know what product the viewer is wanting to purchase.

41. A broadcast receiver operable to receive program data composed of video information and audio information of a broadcast program, and program additional information associated with the broadcast program and including link data used to access a Web server from which detailed information about the broadcast program is available, both of which are broadcast from a broadcast facility using data broadcasting, said broadcast receiver comprising:
a reception section operable to receive said program data and said program additional information of the program according to a viewer's selection;
a generation section operable to automatically generate and store said link data, and viewing information which is a combination of program reception information partially or entirely extracted from said program additional information specifying the broadcast program, and viewers information about the viewer; and
a transmission section operable to provide a service according to an access using said link data, and transmit said viewing information to a Web server which generates service use information analyzed and processed to meet a broadcast program provider's needs, and sends out the resulting shop information to the broadcast program provider.

42. A viewing information server operable to collect viewing information which is a combination of program reception information specifying a broadcast program and viewers information about a viewer, both of which are stored at the time of program reception in a broadcast receiver which is provided plurally and operable to receive program data composed of video information and audio information of the broadcast program, and program additional information associated with the broadcast program, both of which are broadcast from a broadcast facility using data broadcasting, said server comprising:
a collection section operable to collect said viewing information from each of said broadcast receivers;
a generation section operable to generate marketing information by analyzing and processing said collected viewing information to meet a broadcast program provider's needs; and
a sending-out section operable to send out said generated marketing information to the broadcast program provider.

43. The viewing information server according to claim 42, wherein said viewing information coming from each of said broadcast receivers is collectively collected and managed.

44. A shop terminal operable to collect, at the point of sale, viewing information which is a combination of program reception information specifying a broadcast program and viewers information about a viewer, both of which are stored at the time of program reception in a broadcast receiver operable to receive program data composed of video information and audio information of the broadcast program, and program additional information associated with the broadcast program, both of which are broadcast from a broadcast facility using data broadcasting, said shop terminal comprising:
a collection section operable to collect, at the point of sale, said viewing information relating to a product from said broadcast receiver;
a generation section operable to generate shop information by analyzing and processing said collected viewing information to meet a broadcast program provider's needs; and
a sending-out section operable to send out said generated shop information to the broadcast program provider.

45. The shop terminal according to claim 44, wherein, when said program additional information at least includes either image data available in the CM program, or coupon data usable to purchase a product advertised in the CM program,
said image data or said coupon data is received from said broadcast receiver to know what product the viewer is wanting to purchase.

46. An advertiser terminal operable to receive marketing information which is generated by a viewing information server by analyzing and processing, to meet a broadcast program provider's needs, viewing information which is a combination of program reception information specifying a broadcast program and viewers information about a viewer, both of which are stored at the time of program reception in a broadcast receiver operable to receive program data composed of video information and audio information of the broadcast program, and program additional information associated with the broadcast program, both of which are broadcast from a broadcast facility using data broadcasting, said advertiser terminal comprising:
a collection section operable to receive said marketing information from said viewing information server;
an analysis section operable to analyze a correlation between a targeting viewership and a broadcast time of a CM program based on said received marketing information; and
a control section operable to control a broadcast schedule by transmitting, to said broadcast facility, CM control information instructing to optimize the broadcast time of the CM program.

47. A viewing information collection method utilizing a broadcast environment in which a value added service is provided through data broadcasting, wherein
in a broadcast facility provided in a broadcast station,
program data composed of video information and audio information of a broadcast program, and program additional information associated with the broadcast program are generated, and
said program additional information is broadcast together with said program data using data broadcasting,
in a broadcast receiver which is provided plurally and each belonging to a viewer,
said program data and said program additional information of the program are received according to the viewer's selection, and
viewing information which is a combination of program reception information partially or entirely extracted from said received program additional information specifying the broadcast program, and viewers information about the viewer is automatically generated and transmitted to a predetermined viewing information server, and
in said viewing information server,
said viewing information coming from each of said broadcast receiver is received,
marketing information meeting a broadcast program provider's needs is generated by analyzing and processing said received viewing information, and
said marketing information is sent out to the broadcast program provider.

48. A viewing information collection method utilizing a broadcast environment in which a value added service is provided through data broadcasting, wherein
in a broadcast facility provided in a broadcast station,
program data composed of video information and audio information of a broadcast program, and program additional information associated with the broadcast program are generated, and
said program additional information is broadcast together with said program data using data broadcasting,
in a broadcast receiver which is provided plurally and each belonging to a viewer,
said program data and said program additional information of the program are received according to the viewer's selection, and
viewing information which is a combination of program reception information partially or entirely extracted from said received program additional information specifying the broadcast program, and viewers information about the viewer is automatically generated and stored, and
in a predetermined shop terminal,
when a product advertised in a CM program is purchased by the viewer, said viewing information is received from said broadcast receiver,
shop information meeting a broadcast program provider's needs is generated by analyzing and processing said received viewing information, and
said shop information is sent out to the broadcast program provider.

49. A viewing information collection method utilizing a broadcast environment in which a value added service is provided through data broadcasting, wherein
in a broadcast facility provided in a broadcast station,
program data composed of video information and audio information of a broadcast program, and program additional information associated with the broadcast program and including link data to access a Web server from which detailed information about the broadcast program is available are generated, and
said program additional information is broadcast together with said program data using data broadcasting,
in a broadcast receiver which is provided plurally and each belonging to a viewer,
said program data and said program additional information of the program are received according to the viewer's selection, and
viewing information which is a combination of program reception information partially or entirely extracted from said received program additional information specifying the broadcast program, and viewers information about the viewer, and said link data are automatically generated and stored, and
in said Web server,
said viewing information is received at the time of an access by said broadcast receiver using said link data to provide a service according to the access,
service use information meeting a broadcast program provider's needs is generated by analyzing and processing said received viewing information, and
said service use information is sent out to the broadcast program provider.
